(19) United States
(12) Patent Application Publication
(10) Pub. No.: US 2005/0027632 A1
(43) Pub. Date: Feb. 3, 2005

(54) Financial investment advice system and method

(75) Inventors: Marc C. Zeitoun, New York, NY (US); Phillip K. Hsu, Ho Ho Kus, NJ (US); Eric T. Jones, Highland Mills, NY (US); Debra M. Braito, Albertson, NY (US); John L. Lang, Montgomery, NJ (US); Frank R. Malfatto, Ringwood, NJ (US); Ruchir B. Raikundalia, Hazlet, NJ (US); Thomas S. Barron, Scarsdale, NY (US)

Correspondence Address: PILLSBURY WINTHROP, LLP, P.O. BOX 10500, MCLEAN, VA, 22102, US

(73) Assignee: UBS Financial Services, Inc., Weehawken, NJ (US)

(21) Appl. No.: 10/825,156

(22) Filed: Apr. 16, 2004

Related U.S. Application Data
(60) Provisional application No. 60/491,287, filed on Jul. 31, 2003.

(51) Int. Cl. G06F 17/60

(52) U.S. Cl. 705/36

(57) ABSTRACT

In accordance with at least one embodiment of the invention, a computer-based system in which a user, e.g., a financial advisor, an investor, or a client of an investment firm, etc., may engage in an interactive dialog with a software-based investment advice system, hereafter referred to as the “Advisor” to receive analysis of present and potential financial investments. Based on information provided by the user, the Advisor may be configured to determine a recommended investment portfolio including investment allocations designed to meet at least one financial goal. A goal refers to a desired target accumulation of assets in connection with an investor's investment needs based on information a user has provided.

### CROSS REFERENCE TO RELATED APPLICATIONS

This application relates to and claims priority to U.S. Provisional Patent Application No. 60/491,287, which was filed on Jul. 31, 2003.

### BACKGROUND OF THE INVENTION

1. Field of the Invention

The embodiments of the present invention are directed generally to a system and method for providing financial investment advice.

2. Description of Related Art

Financial investors are generally investing in order to achieve one or more financial goals, for example, the purchase of a new or second home, financial independence at retirement, education for one's children or one's self, etc. In connection with such activities investors and would-be investors may establish a relationship with one or more financial advisor(s) employed by a financial investment firm to acquire advice, consultation and/or recommendations on investments that may be made to attain the one or more goals of the investor.

In order to provide the highest level of advice to the investor, such a financial advisor must establish and maintain knowledge of a wide variety of financial investment opportunities. However, it may be difficult if not impossible to do so because of the wide variety of financial investment opportunities and the dynamic nature of various financial markets.

Moreover, presenting investment opportunities and advice to such an investor or would be investor may require detailed analysis and explanation of the effects on the investor's other investments as well as an explanation of the risk associated with the investment opportunities. Such analysis and explanation are potentially time consuming and extremely complicated, thereby being subject to potential error or omission by a financial advisor.

### SUMMARY OF THE INVENTION

In accordance with at least one embodiment of the invention, a computer-based system in which a user, e.g., a financial advisor, an investor, or a client of an investment firm, etc., may engage in an interactive dialog with a software-based investment advice system, hereafter referred to as the “Advisor” to receive analysis of present and potential financial investments. Based on information provided by the user, the Advisor may be configured to determine a recommended investment portfolio including investment allocations designed to meet at least one financial goal. A goal refers to a desired target accumulation of assets in connection with an investor's investment needs based on information a user has provided.

In accordance with at least one embodiment of the invention, a system and methodology solicit a user to enter particular information useful to determine an investor's financial goals and risk comfort, according to a risk tolerance formula.

In accordance with at least one embodiment of the invention, the Advisor may also be configured to project a range of possible investment returns and provide this information to the user in the form of a number of different reports. In this way, the Advisor may provide a comprehensive solution tailored to the an investor's needs.

Additionally, in accordance with at least one embodiment of the invention, the Advisor may be configured to systematically monitor the investor's portfolio and safeguard the investor's best interest.

### BRIEF DESCRIPTION OF THE DRAWINGS

Various embodiments of this invention will be described in detail, with reference to the following figures, wherein:

FIG. 1 illustrates a conceptual depiction of an implementation of at least one embodiment of the present invention;

FIG. 2 illustrates an example of an Overview screen configured in accordance with at least one embodiment of the invention;

FIG. 3 illustrates an example of a Preferences screen configured in accordance with at least one embodiment of the invention;

FIG. 4 illustrates an example of an Investor/Goal Manager screen configured in accordance with at least one embodiment of the invention;

FIG. 5 illustrates an example of a Quantify Goal screen configured in accordance with at least one embodiment of the invention;

FIG. 6 illustrates another example of a Quantify Goal screen configured in accordance with at least one embodiment of the invention;

FIG. 7 illustrates another example of a Quantify Goal screen configured in accordance with at least one embodiment of the invention;

FIG. 8 illustrates an example of a Profile/Asset Allocation screen configured in accordance with at least one embodiment of the invention;

FIG. 9 illustrates an example of a Risk Profile Validation screen configured in accordance with at least one embodiment of the invention;

FIG. 10 illustrates an example of an Allocation Strategies screen configured in accordance with at least one embodiment of the invention;

FIG. 11 illustrates an example of an Investment Proposal screen configured in accordance with at least one embodiment of the invention;

FIG. 12 illustrates an example of a Historical Rate of Return screen configured in accordance with at least one embodiment of the invention;

FIG. 13 illustrates another example of an Investment Proposal screen configured in accordance with at least one embodiment of the invention;

FIG. 14 illustrates another example of an Investment Proposal screen configured in accordance with at least one embodiment of the invention;

FIG. 15 illustrates an example of a Recommended Purchases screen configured in accordance with at least one embodiment of the invention;

FIG. 16 illustrates a portfolio recommendation pop-up window configured in accordance with at least one embodiment of the invention;

FIG. 17 illustrates another example of a Recommended Purchases screen configured in accordance with at least one embodiment of the invention;

FIG. 18 illustrates an example of a Proposal Generation screen configured in accordance with at least one embodiment of the invention;

FIG. 19 illustrates an example of an Acrobat Reader window including a draft proposal in accordance with at least one embodiment of the invention;

FIG. 20 illustrates an example of a Proposal Archive configured in accordance with at least one embodiment of the invention; and

FIG. 21 illustrates an example of a Portfolio Analytics screen configured in accordance with at least one embodiment of the invention.

### DETAILED DESCRIPTION OF EMBODIMENTS OF THE INVENTION

The Advisor may be implemented as a proprietary software application designed to aid users such as financial investment advisors to integrate a consultative advisory process into their business. Thus, the Advisor can enable financial goal setting, risk profiling, asset allocation development, investor proposal generation, and goal monitoring. As part of this suite of capabilities, the Advisor can enable multiple account groupings according to goals, include investor assets held away, goals-based calculators, portfolio level reporting, and portfolio modeling to include specific investment recommendations for investor consideration.

The Advisor may be implemented as an integrated, workflow-based, software application suite based on a financial investment advisory process. The Advisor may also be implemented based on a modular and scaleable infrastructure that includes both asset allocation analysis utility modules and portfolio analytics utility modules. Using these utility modules, financial investment models or solutions may be formulated that may include equities, municipal bonds, mutual funds and managed accounts. Based on these models, a comprehensive investment portfolio proposal may be formulated for presentation to the investor or prospective investor.

Therefore, using the Advisor, a user may review and analyze an investor's asset allocation strategies and current holdings and formulate various investment options based on a common platform containing securities research, money manager reviews and portfolio models. Thus, the Advisor may provide transaction/product-specific investment advice as well as advice at the goal/investment portfolio level by integrating traditional silo-style advice streams such as equities, fixed income, mutual funds, insurance and annuities, managed accounts, retirement planning, financial planning, and estate planning into an advisable investment portfolio.

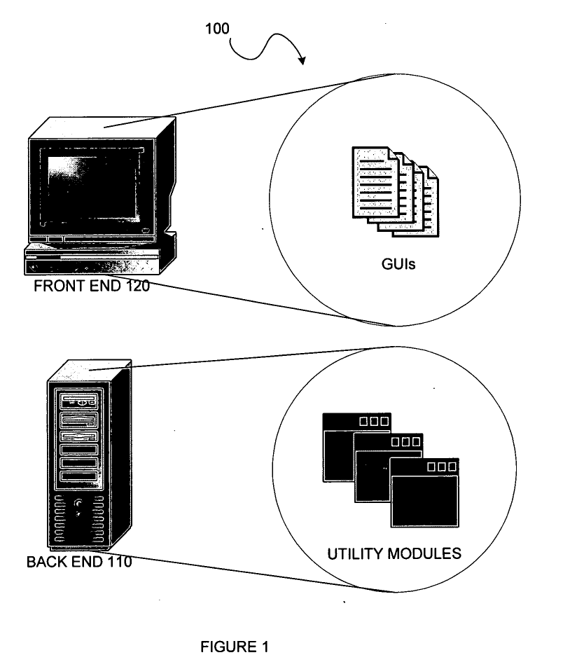

The Advisor may be thought of, conceptually as being implemented using a front-end and a back-end (as illustrated in FIG. 1). The back-end 110 of the Advisor 100 includes various utility modules (explained herein) implemented using software and hardware and performing analyses of the investor's information to generate recommendations regarding investments.

For example, following analysis of an investor's retirement goal(s) by one or more utility modules at the back-end 110, the Advisor's front-end 120 (including various Graphical User Interfaces (GUIs)) may output data indicating the amount of savings that should be accumulated by the first day of retirement, whether the current assets and asset allocation will reach that amount, the assumptions that the analysis is based on, and, potentially, other options that may be used to effectively move toward the investor's goal.

The front-end 120 includes one or more GUIs that are configured to receive information input from a user relating to an investor's goals, risk tolerence and other relevant data (using, for example, a key board, a mouse, or other conventional data entry equipment) and output analysis data to a user (using, for example, a screen that displays text and graphical images). Following analysis of an investor's portfolio, the Advisor outputs, via the front-end, text and graphical data that indicates the results of its analysis via the GUIs. The Advisor may also interpret the results for a user in such a way that the results can be explained clearly to an investor.

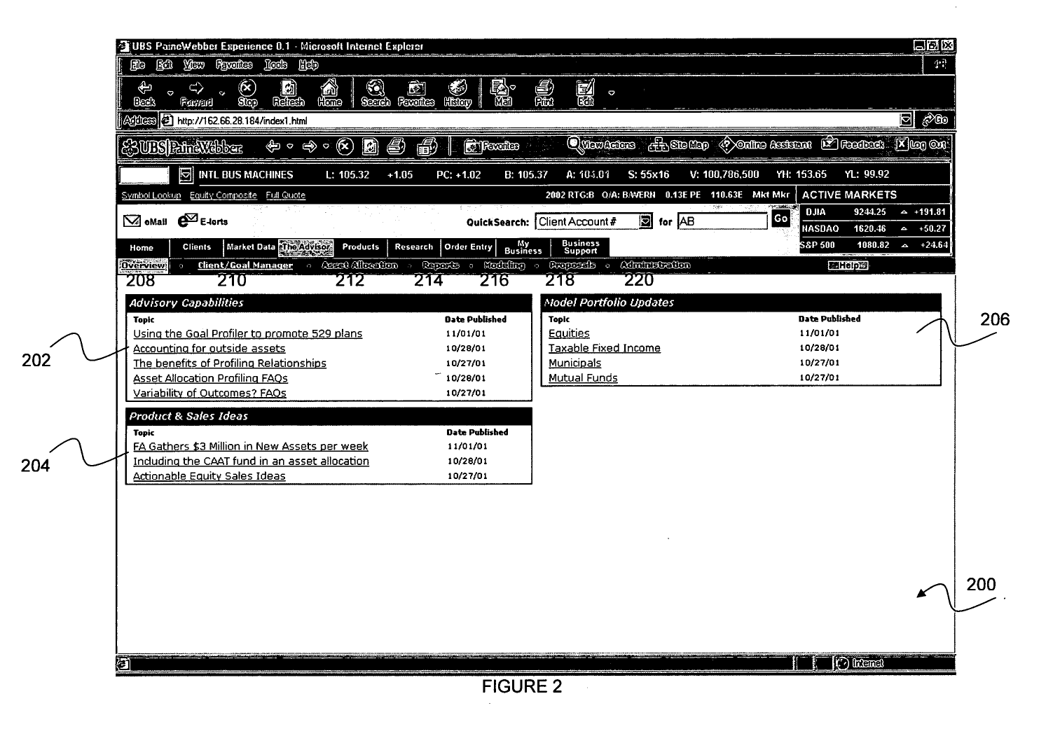

FIG. 2 illustrates an example of an Overview screen 200, which acts as the entry port to the Advisor and provides access to all Advisor functionality. When a user first accesses the Advisor, the user is presented with an Overview screen. The Overview screen may displays icons, which provide links to related information regarding the Advisor including, for example, advisory capabilities such as tutorials, frequently asked questions, success stories, educational content, and news, products and sales ideas such as asset classification changes, financial planning news, and wealth management information, model portfolio updates including changes to equity, fixed income, municipal, and mutual fund model portfolios (e.g., portfolio composition changes, asset allocation recommendations, sector weighting changes, and general news and education for the models.

The Overview screen 200 includes various frames related to products and services available to the investor or another user, e.g., a financial advisor. For example, the screen 200 may include an advisory capabilities frame 202, product and sales ideas frame 204 and model portfolio updates frame 206. Each of these frames may include links to other screens, documents or files provided via the Advisor and related to their respective topics. The Overview screen 200 may include various tabs that may be used to navigate to other screens. These tabs may be located on the upper portion of the screen 200 and include an overview tab 208, Investor/Goal Manager tab 212, Profile/Asset Allocation tab 214, Reports tab 216, Modeling tab 218 and Proposals tab 220.

Thus, a user may navigate through the Advisor using this linear progression of tabs, from left to right, that replicate the circular workflow of the investment consultative process. A user exciting (e.g., clicks on it using a mouse or other wise selects the icon using some type of selection devices such as a mouse, a keyboard, a touch screen, a voice activated selection utility module, etc.) each of these tabs triggers display of other screens associated with each of the tabs, as explained herein in detail.

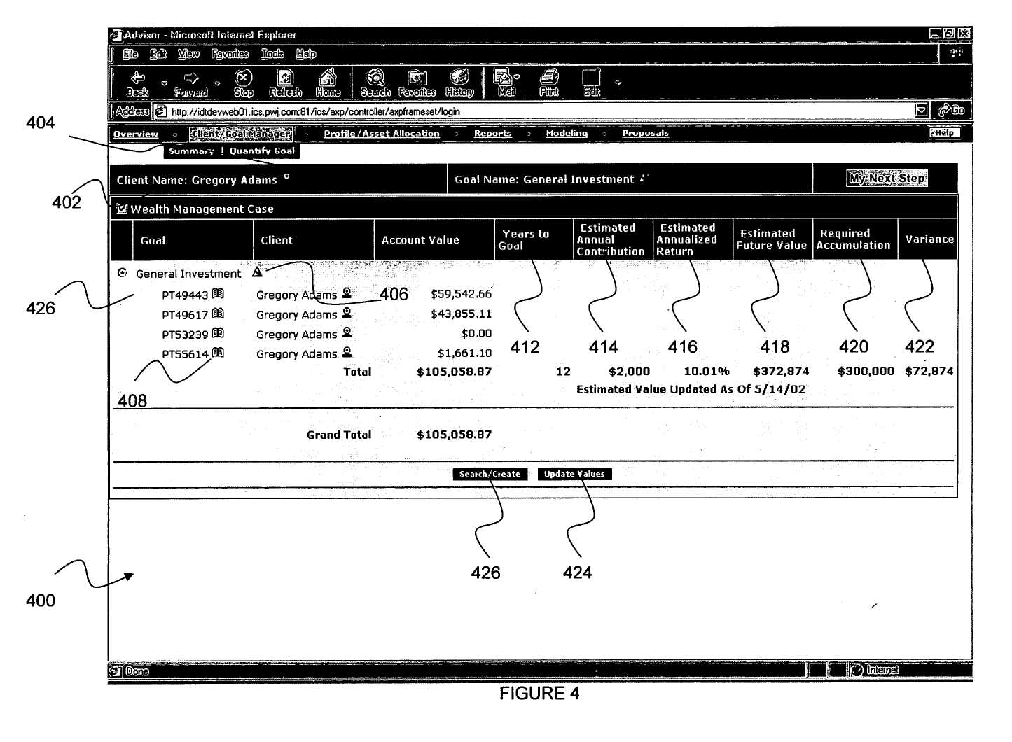

Similarly, the user may excite a “My Next Step” icon (not illustrated in FIG. 2 but illustrated in FIGS. 4-11, 15-18 and 21; hereafter referred to as a MNS icon) that is generally located in the upper right portion of every screen in the front-end and provides a user with the next logical step or choice in their progression through the Advisor.

By exciting the NNS icon, the user may trigger display of a drop down menu that may include various options for selection by the user. The particular options listed depend on what actions the user has already performed in association with a particular investor and particular investor goals. For example, unless a user has quantified a particular goal (explained herein), the Advisor will not provide options to, for example, to create a risk and investment profile with the investor's goal.

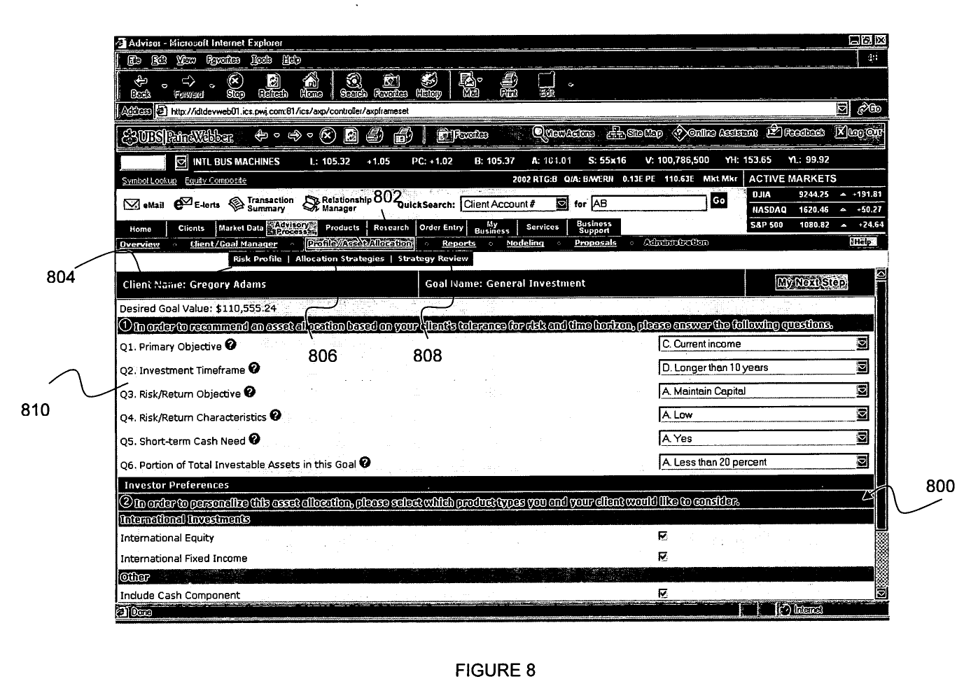

After a goal has been quantified, a user exciting the MNS icon provides, among other options, the option to create a risk and investment profile for the investor's goal. Selection of the Profile/Asset Allocation option triggers display of a Profile/Asset Allocation screen (an example of which being illustrated at 800 in FIG. 8 and explained herein), which includes a series of questions directed at gathering information about a client's risk tolerance, objectives (e.g., capital preservation, current income, partial appreciation, income and appreciation, etc.), investment time frame (e.g., less than three years, three to six years, seven to ten years, longer than ten years), risk return objective (e.g., maintain capital, moderate fluctuations, moderate return, higher returns), risk/return characteristics (e.g., low, some, moderate, moderately high, high), short term cash needs (e.g., yes or no), portion of total assets in this goal, etc.

When a user uses the MNS icon to move to the next screen, the data on the previous screen may be saved automatically.

The Advisor displays several icons, which are accessible whenever an investor, account, or goal is displayed. When a user excites such an icon, a drop down menu of related options appears. For example, an investor icon (e.g., appearing next to a master investor name and the name on each of the investor's accounts) is associated with a drop down menu including options such as view/edit investor preferences, create a relationship, create a goal, edit or remove relationship, and create outside account. For example, if a user wants to create a goal, the user merely selects that option to trigger display of a New Goal Wizard pop-up window (now illustrated) using which a user can select various goal types including building assets for retirement, maintaining assets for current retirement, building assets for child education, building assets for grandchild education, assuring family income in the event of untimely occurrence, purchasing a new or second home, building an investment portfolio, building an emergency fund, etc. Following selection of a goal type and naming it, a screen may be displayed that lists an investor's accounts, from which the user can associate one or more accounts with the goal.

Similarly, a prospect icon (e.g., appearing next to the master prospect name and the name on each of the prospect's account is associated with a drop down menu including options such as view/edit investor preferences, create a relationship, create a goal, edit or remove relationship, create outside account, convert to firm investor and remove prospect.

An account icon (e.g., appearing next to the account number) may be associated with a drop down menu including the option to change a goal assignment. An outside account icon (e.g., appearing next to an outside account number) may be associated with a drop down menu including options such as change goal assignment, view/edit outside account, and remove outside account. A goal icon (e.g., appearing next to the goal name) may be associated with a drop down menu including options to change goal type/name and to reassign accounts.

A user may trigger display of the Overview screen 200 by navigating from any one of various other screens included in the Advisor (e.g., an Investor/Goal Manager screen, a Quantify Goal screen, a Profile/Asset Allocation screen, a Portfolio Analytics screen, a Proposal Generation screen and a Recommended Purchases screen, each explained herein). Similarly, while viewing the Overview screen 200, the user may trigger display of various other screens included in the Advisor.

To use the Advisor, a user must select an “investor” or a prospective investor(also referred to as a “prospect”) to work with. The user can search for investors in the same way the user would with any other application. An investor is some person (or other legal entity) who already has a brokerage account at a financial investment firm associated with the Advisor.

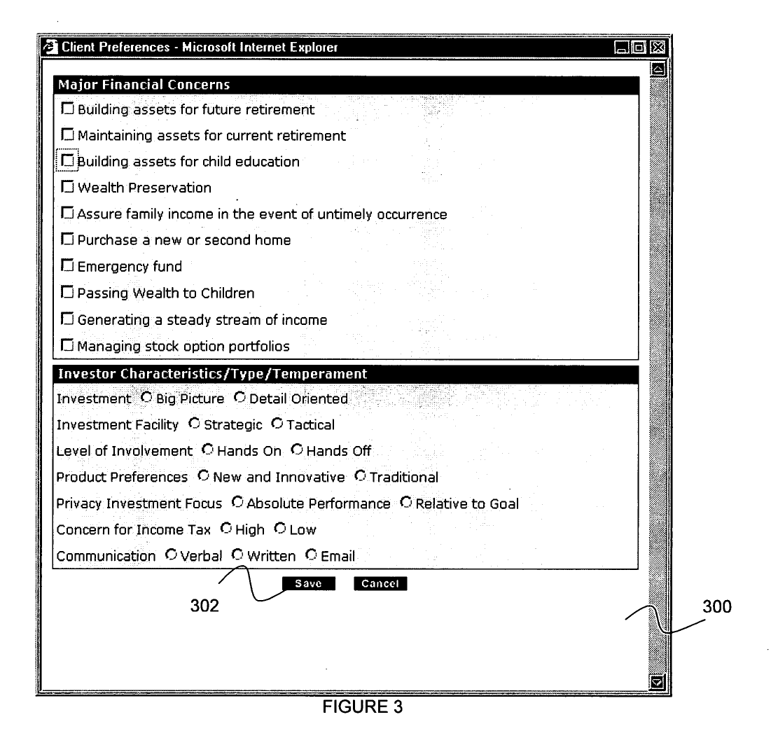

Once a user has identified an investor or has created a prospect, the user can capture the background information and investment preferences of the investor or prospect to customize communication on topics of interest and offer suitable investment solutions. To capture this information, a user may excite the icon located next to the investor or prospect's name and select a View/Edit Preferences option from the related drop down menu. This will trigger display of a Preferences screen (an example of which being illustrated as 300 illustrated in FIG. 3) that allows entry and saving of information regarding the prospective investor's major financial concerns, investor characteristics and investment products. These include names of other advisors, attitudes towards investing, preferences in communication, etc. The user may then trigger saving of this entered data by exciting a Save icon 302. This data may be updated by the user at the user's discretion.

When the Preferences screen 300 is displayed, data is imported to the screen from one or more previous screens as appropriate, e.g., including goal type, investor name, goal and account values and current allocation.

While viewing the Overview screen 200, the user may excite of the Investor/Goal Manager tab 212 to trigger display of an Investor/Goal Manager screen 400(an example of which being illustrated in FIG. 4). From that screen, a user can excite the Search/Create icon 410 to trigger display of an Investor Selection Wizard pop-up window (not illustrated). The Investor Section Wizard pop-up window enables a user to identify an investor by inputting one or more pieces of data including, for example, an associated financial advisor, account number, investor last name, account short name, social security number/tax identification number and/or money manager. After a user has input this data, the user may excite one of the search icons to trigger a search for a particular investor based on the input data. Following completion of the associated search, various investors that meet the criteria input by the user, and their associated account information, may be displayed for a user to select from on a Search Results screen (not displayed in detail). Following the selection of a particular investor, the Investor/Goal Manager screen 400 will again be displayed, which may display all accounts associated with the selected investor and any previously created financial goals. The Investor/Goal Manager screen 400 may also display an indication of progress toward goal values once a goal has been created and quantified (explained herein).

If an investor's goals have no market value, a dialog box is displayed with the text “You cannot proceed forward in the Advisor with a goal that has no market value. Please add an account with assets (internal or external account) to this goal before proceeding”. If a user clicks on the MNS icon on any screen, a dialog box is displayed that inquires if the user wants to save previously entered data.

FIG. 4 illustrates an example of an Investor/Goal Manager screen 400, which acts as the location from which all investor, goal, and account icon functions are executed within the Advisor. The Investor/Goal Manager screen is configured to display all accounts associated with the investor as well as their financial goals and an indication of their progress toward attaining these goals. The Investor/Goal Manager screen enables a user to view data associated with an investor's goal(s), develop additional goals for a client, establish relationships between various accounts and other administrative functions. From the Investor/Goal Manager screen, the user can determine an investor's preferences, create additional goals, combine accounts under the same goal by forming relationships and add outside accounts to the goal of an investor. Also from this screen, all investor, goal, and account icon functions can be executed within the Advisor.

At the Investor/Goal Manager screen 400, the user can define the goal context, i.e., the goal context, through which the user navigates within the Advisor. The user may change the particular goal associated with the investor's accounts by selecting a checkbox (not displayed) next to a particular goal name 402, e.g., retirement, education etc. The Investor/Goal Manager screen 400 also provides a display of the account values, years to goal, estimated annual contributions, estimated annualized return (based on a current allocation), estimated future value, required accumulation (of assets for goal) and variance. An external account, i.e., an account maintained by an organization other than the one associated with the Advisor, may be distinguished from an account maintained by the organization associated with the Advisor, by specific indicia, for example, a black and white icon for drop down functions as opposed to two letters followed by numbers' with a color icon for drop down functions for internal accounts, e.g., those accounts maintained by the organization associated with the Advisor.

All investor accounts that are “owned” by the selected investor, and any investor accounts that are linked to the displayed investor, via an investor relationship (i.e., a recognized familial, business or legal relationship, explained herein), may be displayed on the Investor/Goal Summary screen 400. This superset of investor relationship accounts may provide the universe from which accounts may be added, removed, or reassigned to goals.

While the Investor/Goal Manager screen 400 is displayed, an investor's name, the goal(s) that have already been set and any related accounts may be displayed. A user may also excite several sets of icons which may be associated with various drop down menus and pop-up windows relating to an associated item, e.g., investor name, goal or account number and also a prospect icon. Display of investor, goal, account and prospect related pop-up windows and drop menus may be triggered by a user exciting icons associated with these windows and menus respectively. For example, excitation of the Investor icon 404 (located in the proximity of an investor name) may trigger display of an investor-specific drop-down menu, which may include investor-specific options (e.g., view/edit investor preferences, create a relationship between this investor and others, create a goal, edit/remove an existing investor relationship, create an external account, etc.).

Similarly, excitation of the Goal icon 406 may trigger display of a goal-specific drop-down menu including various goal-specific options (e.g., change a goal type/name, reassign an account to another goal, create an external account, etc.). Also, excitation of the Account icon 408 may trigger display of an account-specific drop-down menu, which may include a list of account-specific options (e.g., change a goal assignment, view/edit an account, remove an account, etc.). Exciting an external account icon (not illustrated in FIG. 4) may trigger display of an external account specific dialog box that may include a list of external account-specific options (e.g., change a goal assignment, view/edit an external account, remove an external account, etc.; alternatively, the user may be prompted to enter various data including, for example, an IRA qualified plan code, an associated custodian, bank or broker dealer, and the option of entering an indication of an allocation of external assets; a user electing to save this data may trigger display of a confirmation message verifying that an outside account(s) has been created and the account has been assigned to a particular goal). If a Prospect Account icon (i.e., an icon relating to accounts of a prospect or prospective client, explained herein but not illustrated) is selected, display of a prospect-specific drop-down menu may be triggered including options such as view/edit investment preferences of the prospect, create a relationship for the prospect, create a goal, edit/remove a relationship, create an external account, convert the prospect to an investor, remove prospect, etc.)

While viewing the Investor/Goal Manager screen 400, the user may perform an account search by exciting the Search/Create icon 410. If a selection is then made from a resulting search result set, display of a dialog box may be triggered and the Investor Summary screen 400 may display with the selected new investor context. If the search is canceled, the dialog box may disappear and the Investor Summary screen 400 may display with investor context unchanged.

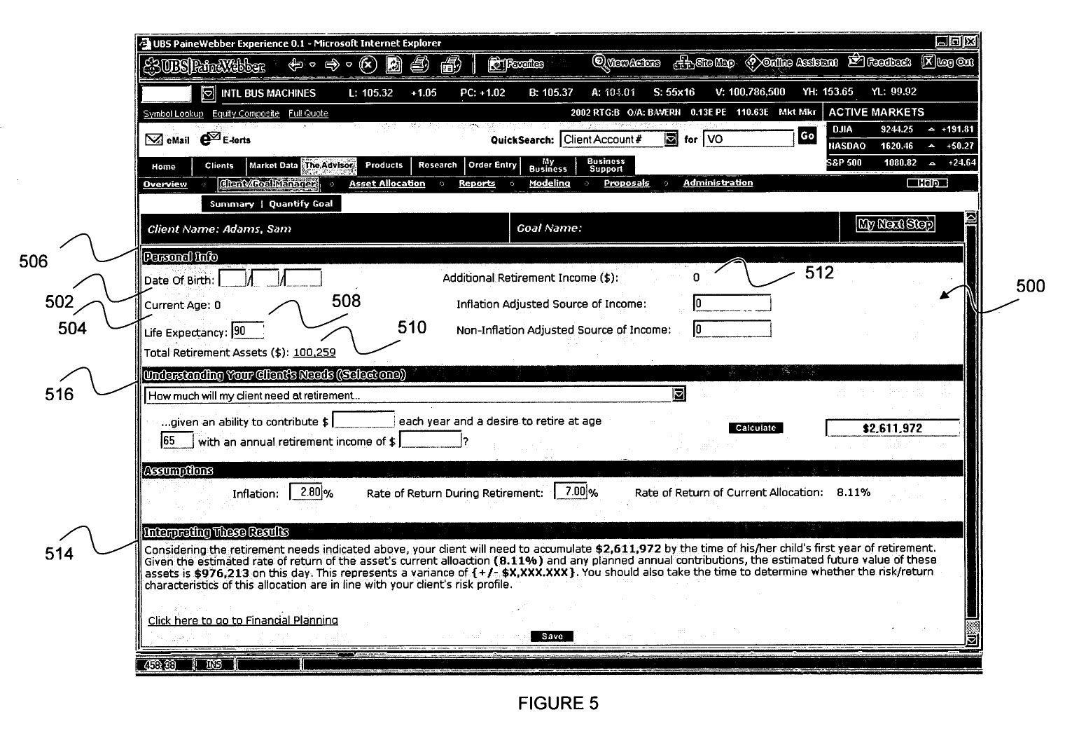

The value in the Years to Goal field 412 may be determined based on data input to or displayed on a Quantify Goal screen (an example of which being illustrated in FIG. 5, explained herein). If that value has not been determined, the field will remain blank.

The value in the Estimated Annual Contributions field 414 is similarly related to the Quantify Goal screen. If this value has not been determined, the field also remains blank. The estimated contributions value represents the total amount of future annual contributions the investor would have to provide to this account to achieve the goal. This value sums all of the annual contributions for the number of years left to the investor's goal. Future value calculations incorporate this annual amount, and assume that these contributions occur each year.

The value in the Estimated Annualized Return field 416 is based upon the goal's current asset allocation historical rate of return.

The value of the Estimated Future Value field 418 is based upon the goal's current asset allocation grown at its historical rate of return inclusive of the annual contributions (grown at an equivalent rate); the time constraint associated with this value is determined by the Years to Goal field 412. This future value represents the total assumed accumulated value of the listed accounts, assuming the specified estimated annualized return over the identified time horizon. The value of the Required Accumulation field 420 is determined based on data input to or displayed on the Quantify Goal screen. If this value has not been determined, the field will be blank. The value of the Variance field 422 is determined based on the difference between the value in the Expected Future Value field 418 and the value of the Required Accumulation field 420. If the goal has not been quantified, this field will be blank.

If a user adds assets (investor account or external assets) to a particular goal, deletes or reassigns assets from a goal with a quantified value, the values of the Estimated Annualized Return field 416 and Estimated Future Value field 418 must be recalculated. Thus, a user may excite the Update Values icon 424 to trigger such a recalculation.

If only one goal is assigned to an investor in context, that goal is displayed in the Goal Name field 426, and the user may be enabled to navigate to other screens provided by the Advisor relating to Goal analysis (e.g., any screen that is configured to provide financial analysis of a goal) without having to explicitly select a goal. However, if an investor has multiple associated goals, before exiting the Investor/Goal Manager screen 400 to proceed to other screens provided by the Advisor relating to Goal analysis, the user must select a goal to define the goal context through which the Advisor will work.

As alluded to above, the Advisor may be used as a prospecting tool, i.e., a tool used to turn prospective investors (“prospects”) into actual investors, and can be used to generate custom investment proposals. However, to do so, the user must first create a prospect. Once the user creates a prospect, the user can attach outside accounts, recommend asset allocations, and archive proposals. Data associated with prospects may remain in the system, and the user can update data on them as often as the user wishes. Prospects can also be linked to other investors to create larger relationships.

The user may use the above-described Investor Selection Wizard pop-up window to select a prospect by exciting an Investor icon (for example 404 in FIG. 4) to trigger display of an associated drop-down menu, and then select various options to create a new prospect by triggering display of a New Prospect Wizard pop-up window (now illustrated). The user may then enter and save data indicating the prospect's full name, address, and phone number(s). Once the prospect has been created, a user can associate external accounts with it (e.g., by inputting data indicating whether the account is an IRA qualified plan, identify the custodian/bank/broker dealer and the allocation of external assets), recommend asset allocations, and archive proposals (as explained herein). Such prospects may be archived by the Advisor and a user can update related data. Just like investors, prospects have accounts that may be linked to a goal.

As explained above, the Advisor works within a single goal context, which means that risk profiles, asset allocations, and proposals are established one goal at a time. Thus, once a user has selected a specific investor or prospect with whom to work, a goal can be created. A goal goes beyond the traditional single-account view. Every account in the Advisor must be assigned or related to a goal. As a matter of convention in the Advisor, goals may be associated with one or more investor accounts, but each account may only be assigned to one goal. Initially, all accounts brought into the Advisor will have a default goal associated with them, General Investment. This goal may then be customized according to the investor's investment objectives. Possible goals may include, for example, building assets for future retirement, maintaining assets for current retirement, building assets for child's education, preserving wealth, assuring family income in the event of untimely occurrence, purchasing a new or second home, maintaining an emergency fund, passing wealth to children, generating a steady stream of income or managing stock option portfolios.

To create a goal, from the Investor/Goal Manager screen 400, a user may excite the Investor icon 404 located next to the investor name, and then excite a create goal option from an associated drop-down menu. This may trigger a New Goal Wizard pop-up window (now illustrated) to be displayed. Next, the user may excite a goal type drop down list and select a goal type from the list. By default, the name of the goal type may appear in a Goal Name box. However, to change the name, a user may merely type a new name for the goal in the Goal Name box and excite the a Next icon. The user can also reassign accounts from one goal to another by using the Reassign Accounts option accessible on the drop-down menu associated with the Goal icon 406. If no accounts remain assigned to a particular goal, the goal will be deleted. This in effect removes the goal. If there is only one goal and the user wants to reassign an account to a new goal, the user may be prompted to create a new goal.

The user may then save new goals and changes to goals, which will trigger display of a confirmation message verifying that the additions or changes have been completed successfully. Subsequently, the Investor/Goal Manager screen 400 displays the new or changed goal with the accounts selected to fulfill the goal.

Just as the user must select a specific investor or prospect to work with, the user must also work with a particular goal when performing financial investment analysis using the Advisor. For example, suppose the Adams Family is made up of three investors: Sam (husband/father), Jane (mother/wife), and Joey (son) that are associated with other via an established relationship (explained herein). In addition, they have multiple goals: general investment, retirement, and education. The user must select which goal among the relationship the user wants to work with in the advisory process. To select a goal to work with, from the Investor/Goal Manager screen 400, a user may excite the Goal icon 406 located next to the investor goal the user wishes to work with. To change the goal/type name, the user can customize the goal associated with a set of investor accounts using the Goal Type/Name option accessible on the drop-down menu associated with the Goal icon 406. From the Investor/Goal Manager screen 400, the user may excite the Goal icon 406 next to the goal the user want modify, and then excite the Goal Type/Name option. This may trigger display of a Goal Manager Wizard pop-up window (not illustrated) displaying all accounts associated with the selected goal. Once a goal has been created, the user may use one of three built-in calculation utility modules to “quantify” the goal's future value or required accumulation.

Once the user has chosen a specific investor and goal to work within the Advisor, the “logical” progression is to quantify the investor's goal. The Quantify Goal screen functionality may allow the user to quantify a goal type by defining a goal value (i.e., associating goal achievement with a particular dollar amount to be reached by the account(s) associated with the goal) with the assistance of a correlated financial planning utility module (each goal type may be associated with a financial planning utility module).

To quantify a goal, a user may view a Quantify Goal screen (either by exciting the quantify goal icon on the Investor/Goal Manager screen or by exciting the MNS icon and selecting the quantify goal option) and providing various pieces of data. The goals of building developing an employee retirement plan or maintaining assets for retirement may be analyzed using a retirement calculation utility module, whereas the goal of building assets for a child's or grandchild's education are analyzed using the education calculation utility module. Further, the goals of purchasing a new or second home, starting a business, managing business assets for growth, general investment, or creating an emergency fund may be analyzed using a general savings calculation utility module.

Each of the calculation utility modules included in the Advisor may default to an associated goal type. If the user wants to re-quantify the goal value with a different calculation utility module, s/he must first change the goal type. If the goal type is changed, the associated quantified goal assumptions may be deleted. If the user changes a goal type to one that has a different corresponding calculation utility module, all quantified goal values may be deleted. If the user changes a goal type to one that has the same corresponding calculation utility module, all quantified goal values will be remain unchanged.

During calculations for quantifying a goal, the following formula may be used to calculate the future value (fv) of a financial investment:

$$fv = - \frac{- pmt + {( 1 + ir )}^{np} pmt + {ir ( 1 + ir )}^{np} pv}{ir} \qquad ( 1 )$$

where pmt is the payment value, ir is the interest rate, np is the number payment periods, and pv is present value of the investment.

Therefore, the required payment may be calculated using the equation:

$$pmt = - \frac{ir ( fv + {( 1 + ir )}^{np} pv )}{- 1 + {( 1 + ir )}^{np}} \qquad ( 2 )$$

Arranged differently these relationships allow a calculation of the present value (pv) of an investment as follows:

$$pv = - \frac{{( 1 + ir )}^{- np} ( fv ir - pmt + {( 1 + ir )}^{np} pmt )}{ir} \qquad ( 3 )$$

This allows a calculation of the number of payment periods based on this information as follows:

$$np = \frac{Log [ \frac{- fv ir + pmt}{pmt + ir pv} ]}{Log [ 1 + ir ]} . \qquad ( 4 )$$

For each of the calculation modules, all calculations are in future dollars. Therefore, the rate of return is not adjusted by inflation. Additionally, contributions and distributions occur at the end of the year. The inflation rate may be assumed to be a default, e.g., 3.00%.

FIG. 5 illustrates an example of a Quantify Goal screen 500 displaying various fields associated with the retirement calculation module. If the user selected a retirement goal, the retirement calculation utility module enables the user to assess an investor's retirement savings strategy and determine whether or not they will be able to achieve their cash flow needs. The retirement calculation utility module asks basic questions about the investor's current savings, anticipated retirement age and desired annual retirement income.

On the Quantify Goal screen 500, if the goal is for only one investor, the date of birth and current age may be pre-populated as well as the total retirement assets and the data in the assumptions section. Alternatively, the Date Of Birth field 502 requires that the user enter the data in mm/dd/yyyy format. The corresponding age will be displayed on the Quantify Goal screen 500 in the Current Age field 504 within the Personal Information section 506. The current age will be an input field when calculating the goal value.

The Current Age field 504 is only populated (default: primary account holder's date of birth) when one of the goals of the investor relates to retirement. If multiple accounts are associated with a goal, the Current Age field 504 of the investor will default to zero. The Life Expectancy field 508 may default to some predetermined value, e.g., 90. However, the user can input a different value. The Total Assets field 510 displays the aggregate value of all associated goal accounts and displays. The Total Assets field 510 may be an input field when calculating the goal value.

The Additional Retirement Income field 512 allows for the inclusion of additional asset values not accounted for elsewhere in the Advisor.

The Interpreting These Results section 514 may display the estimated future value of the investor's assets based on the investor's current savings strategy, the estimated amount the investor will need at retirement, and the variance between the amount accumulated and the amount needed. After reviewing the investor's risk and investment profile and allocation strategy, if the results indicate a shortfall in the desired retirement cash flow, the investment proposal may display both the achievable cash flow as well as additional savings required to meet the desired goal.

In the retirement calculation utility module the income goal, social security and other retirement income may increase by inflation. Annual contributions and pension amounts may not increase by inflation. The income goal may be offset by additional retirement income, and the income goal and all other sources of income will start at retirement. Annual contribution will stop at retirement. The pre-retirement rate of return is based on the current allocation. The rate of return during retirement will be a fixed percentage for all allocations.

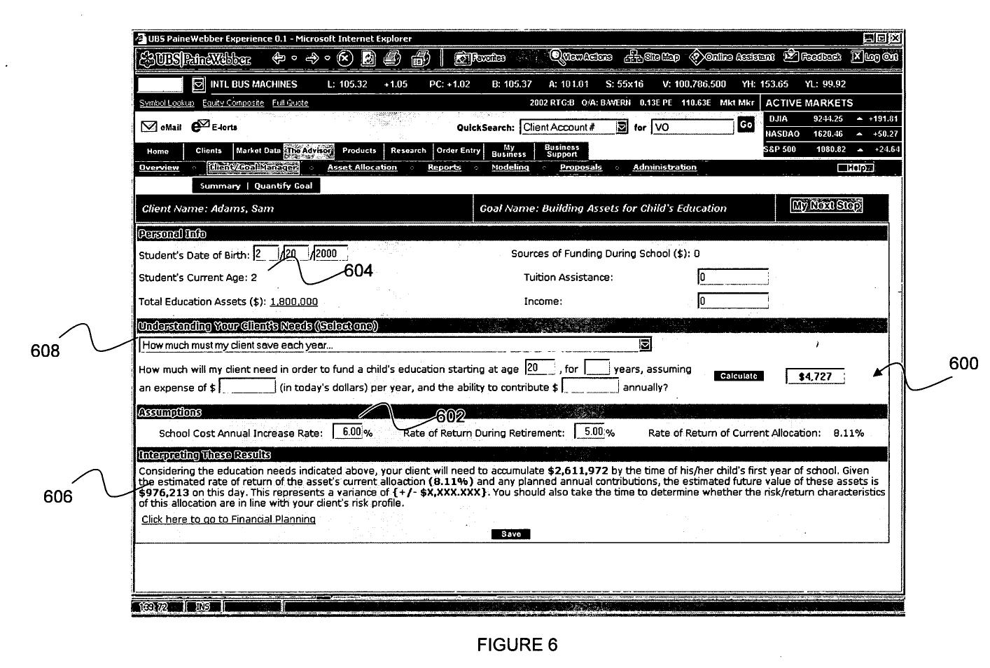

FIG. 6 illustrates an example of a Quantify Goal screen 600 displaying various fields associated with the education calculation utility module. If the user has selected an education goal, the education calculation utility module may be used to assess the investor's education savings strategy and determine whether or not the investor will be able to achieve the cash flow needs. The education calculation utility module asks basic questions about current savings, annual tuition, and other anticipated sources of income to assist in covering school costs.

Various education fields allow for the numeric value inclusion of income data including scholarship amounts, loan amounts, and supplemental income amounts for this goal. The education calculation utility module utilizes a school cost annual increase rate; this rate may be input by the user in the Annual Increate Rate field 602. The Annual Increase Rate field 602 allows the user to enter an increase rate to be applied to the annual school cost as part of determining the goal value. The Current Age field 604 will always default to 0 for the education calculator.

The Interpreting These Results section 606 outputs a calculation of the estimated future value of the investor's assets based on their current savings strategy versus the estimated amount the investor will need at the time of his/her child's first year of school, and the variance between the amount accumulated and the amount needed. After reviewing the investor's risk and investment profile and allocation strategy, if the results indicate a shortfall in the desired education funding goal, an investment proposal may display both the achievable cash flow as well as additional savings required to meet the desired goal.

In the education calculation utility module, annual education expenses may be increased by an inflationary factor that may be changed (the default may be, e.g., 7.00%). Annual contributions last to the end of the education period. Contributions may not be increased annually by inflation. Additional education income (e.g., scholarships, loans, and other education income) may be increased by inflation to the start of education. The amount then may remain flat during the education period. Education expenses may be offset by additional education income and annual contribution during the education period. The rate of return during the education-funding period is based on the current allocation. The rate of return during the education funding period is the same for percentage for all allocations.

For the education calculation utility module, various pieces of personal information must be entered including current age, date of birth (this field may remain blank if there are multiple investors associated with the accounts), total education assets, total value of selected accounts, and sources of funding during school.

The calculation algorithm performed by the education calculation utility module may be explained as follows. First, the dollar value of scholarships, loans, and supplemental income is inflated to the start of the education period. Next, the future value the education expense is calculated for each year of school based on the education increase rate. Subsequently, the inflated value of scholarships, loans, and supplemental income is subtracted from the future value of the expense. Next, the present value of the result of the subtraction (adjusted by the rate of return during the education period) is calculated. This amount is the amount needed at the start of the education period. Subsequently, the requisite annual savings is calculated with the payment formula to the start of education using the sum of present valued goals (FV) Total Education Assets (PV), and the current allocation rate of return. The education calculation module may make various assumptions including an assumed rate of return during education, an estimated rate of return of a current allocation and an annual increase rate in school costs.

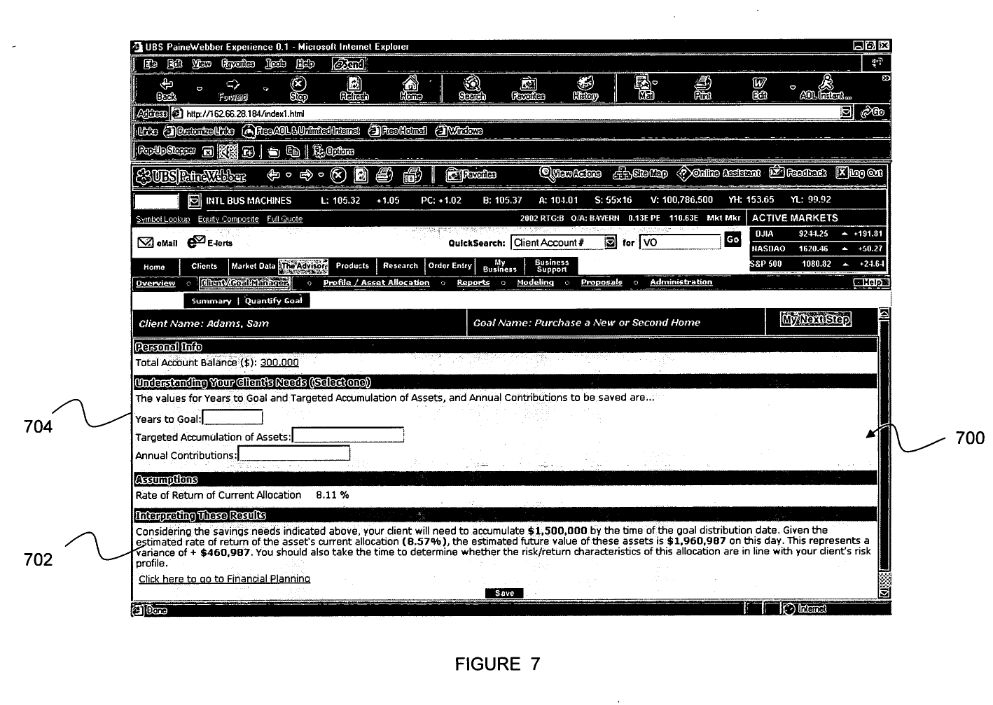

FIG. 7 illustrates an example of a Quantify Goal screen 700 displaying various fields associated with the general savings calculation utility module. If the user selected a general savings goal, the general savings calculation utility module enables estimating an investor's ability to meet a future goal (such as the purchase of a home). The general savings calculation utility module asks basic questions about anticipated annual contributions, years to the goal, and the anticipated goal amount. The amount of savings goal is the dollar figure that the savings calculator uses to determine the annual savings amount.

The Interpreting These Results section 702 calculates the estimated future value of the investor's assets based on their current savings strategy, the estimated amount the investor will need at the time of goal distribution date, and the variance between the amount accumulated and the amount needed. After reviewing the investor's risk and investment profile and allocation strategy, if the results indicate a shortfall, the Investment proposal will display the additional savings required to meet the desired goal.

On the Quantify Goal screen, the user has the ability to alter any of the information that has been automatically populated in any of the fields or boxes. In the area headed “Understanding Your Client's Needs” (see 516, of FIG. 5, 608 of FIG. 6 and 704 of FIG. 7), the user can select from a drop down menu associated with each calculation utility module, which in turn allows the user to fill in additional information relating to the investor. However, when the Quantify Goal screen is displayed, various pieces of data may be automatically populated in various information fields, e.g., life expectancy, inflation percentage, rate of return during retirement and rate of current allocation; the first three pieces of data in these fields may be edited by the user.

Once the user has selected an investor to work with, the user can also associate other related investors' accounts with the investor by creating a relationship. The user can also combine accounts that belong to different investors in association with a single goal. For example, the user can link one or more accounts of Sam Adams (husband) to one or more accounts of Jane Adams (wife) to create a common retirement goal or an educational goal for Joey Adams (son). However, an investor relationship must first be explicitly created before associating accounts, from different investors, to shared goals.

To create a relationship, the user may access the Investor/Goal Manager screen (an example of which being illustrated in FIG. 4), excite the Investor icon 404 located next to the investor name, and then excite the Create Relationship option from the associated drop-down menu. This may trigger display of a Relationship Creation Wizard pop-up window (not illustrated) using which the user can search for investors or prospects with whom the user can create a relationship with the presently identified investor. It is worth noting that the user may create a relationship either with another investor or another prospect simply by selecting either as the investor type specified in a search. The user may then specify various pieces of identification data using fields on the pop-up window, e.g., financial advisor identification, account number, investor or prospect last name, account short name, social security number/tax identification number, etc. Next, the user may trigger a search to trigger display a screen including all investors or prospects that meet the search criteria. The user may then select from the search results to identify the other party or parties to the relationship, indicate the type of relationship from those included on a relations drop-down menu, and select the relationship intensity, e.g., tight or loose (a “tight” relationship may represent a close familial relationship such as a spouse, sibling, child, or parent, while a “loose” relationship may represent an extended familial, business, or social relationship). Following saving of the established relationship, the Investor/Goal Manager screen 400 may then display the new relationship(s) and all respective accounts.

Over time, the user may wish to modify relationships created in the Advisor. To accomplish this, the user may select an Edit/Remove Relationship option, which is accessible as part of the drop-down menu associated with the Investor icon 404 on the Investor/Goal Manager screen 400. This will trigger display of a Relationships Wizard pop-up window including a relations drop-down menu and an intensity drop-down menu as explained above. To remove a relationship, the user may simply excite a Remove icon next to the relationship the user want to remove, which will in turn trigger a Remove Relationship pop-up window where a user may confirm instructions to remove the relation (a confirmation message may then appear). The user may then save the changes to the relationship and the Investor/Goal Manager screen 400 may subsequently display changes to the relationships and the respective accounts.

Creation, modification and removal of relationships involving prospects rather than investors or prospects and investors may be handled similarly.

In accordance with at least one embodiment of the invention, the Advisor may provide risk profiling and asset allocation analysis for investor/prospect interaction. To develop an asset allocation recommendation, and therefore, an investment proposal, investors may be profiled for their risk tolerance and the time horizon associated with their investment goal. There are various ways to trigger a determination of an investor's or prospect's risk and investment profile, for example, a user may excite the MNS icon located on various screens of the Advisor, and then excite the Create Risk Profile option. Alternatively, a user may excite the Profile Asset Allocation tab 802 followed by a Risk Profile subtab 804. In either event, display of a Profile Asset Allocation screen 800 is triggered; this screen 800 may display a series of questions about the investor 810, the answers to which may be used to determine the client's investment philosophy and risk tolerances. As explained herein, this risk and investment profile may be used by the Advisor to assess the possibility of proposing various financial investment options to the user.

The risk and investment profile includes indicia of the user's investor's objectives, timeframes, risk/return characteristics, and investor preferences to determine his/her tolerance for risk and time horizon. To personalize the investor's asset allocation, the user can select whether to consider various income sources including, for example, international equity or international fixed income. The user can also indicate to what extent tax effects should be taken into consideration when formulating options.

Various questions may be included to enable a determination of risk, time horizon, current income, and total return scores. These scores may be used to determine a recommended asset allocation displayed within one of a number of broad portfolios along an efficient frontier and the breakout of the broad asset classes at the subclass and style levels. The efficient frontier is one effective way to analyze the interaction of expected risk and return. The first step in constructing an efficient frontier is to plot every combination of assets (e.g., different asset allocation strategies) on a risk/return graph. Thus, the efficient frontier represents the line created by plotting and connecting all asset class combinations which produce the highest return for each degree of risk taken.

The Advisor then may calculate separate scores for risk tolerance, time horizon and income form preference. Each score then determines the investor's risk and investment profile. For example, an investor's risk tolerance score may be calculated and mapped to one of a number of risk levels, e.g., seven risk levels: 1 (lowest) to 7 (highest). The mapping may be as illustrated in Table I (below).

TABLE 1

| Raw score | Risk level |
|---|---|
| <10 | 1 (Very |
| | Conservative) |
| 10-19 | 2 (Conservative) |
| 20-29 | 3 (Moderately |
| | Conservative) |
| 30-39 | 4 (Moderate) |
| 40-49 | 5 (Moderately |
| | Aggressive) |
| 50-63 | 6 (Aggressive) |
| >637 | (Very Aggressive) |

A time horizon score, once calculated, may then be mapped to one of a number of time horizons, e.g., three time horizons: short, intermediate and long. Thus, the mapping may be raw score less than ten is a short time horizon, raw score ten to nineteen is an intermediate time horizon and raw score greater than nineteen is a long time horizon.

Additionally, an income form preference scoring process may generate separate current income and total return scores. The investor's preference may be determined by whichever is the higher score. In the case of a tie, a total return preference may be assumed.

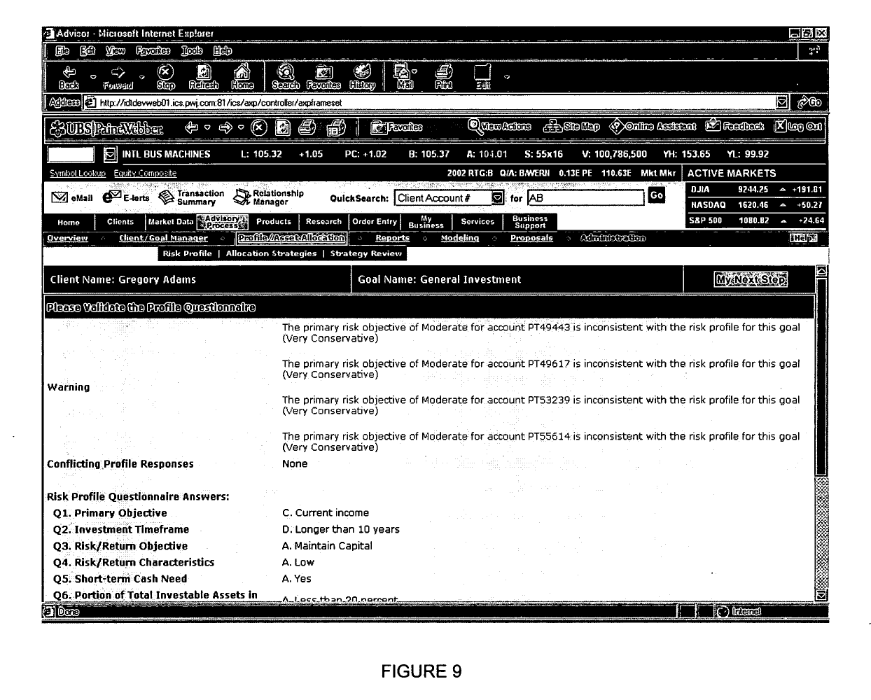

Following entry of the risk and investment profile data, a preliminary determination as to whether there are any conflicts in the data is performed. If there are conflicts, they may be notified to the user and the user may be given the ability to modify the risk and investment profile. Thus, the risk and investment profile may be validated by displaying the responses on a Risk Profile Validation screen to determine accuracy relative to the goal objectives and investor risk and investment profile. An example of such a Risk Profile Validation screen 900 is illustrated in FIG. 9.

The Validation screen 900 may detail whether or not the goal's risk/return objectives meet the investor's tolerance levels. More specifically, if an account specific investment objective differs from an associated goal profile risk level, a message indicating that there is a conflict with the goal profile risk level may be displayed. Additionally, only profile conflict messages may be displayed depending on the scenario. For example, if answers indicate that an investor desires capital appreciation but indicates a relatively short time frame, a message may displayed suggesting the review of various answers on the questionnaire because the goals seem contradictory. Answers may indicate an investor's desire for consistent returns; however, other answers may indicate a desire for capital appreciation. In such a case, a message advising review of the questionnaire answers.

Similarly, an investor's choice of a portfolio with higher fluctuation may conflict with their desire to preserve or maintain capital, the choice of a portfolio that invests in non-income producing securities may conflict with the goal to produce current income, and the choice of a portfolio with higher fluctuation may conflict with the short time frame. Additionally, an investor's desire for high returns may conflict with their ability to handle only moderate fluctuation. In each of these situations, the Advisor may generate customized messages to the user requesting the user and/or investor to review the answers to recognize and/or rectify a conflict.

If there are no conflicts, the resulting risk and investment profile may be saved in association with the particular investor's particular goal.

The risk and investment profile may be associated with only one goal of an investor or, alternatively, with more than one goal or all goals of the investor. This type of flexibility provides the user with the option to effectively use all investor data that is accessible.

Once the risk and investment profile has been completed, exciting the MNS icon triggers display of an option to view or modify a target allocation by selecting a Modify Target Allocation Strategies option from the MNS drop down menu. The user may also elect to view or modify a target allocation by exciting the allocation strategies tab included in the set of tabs provided on various screens included in the Advisor.

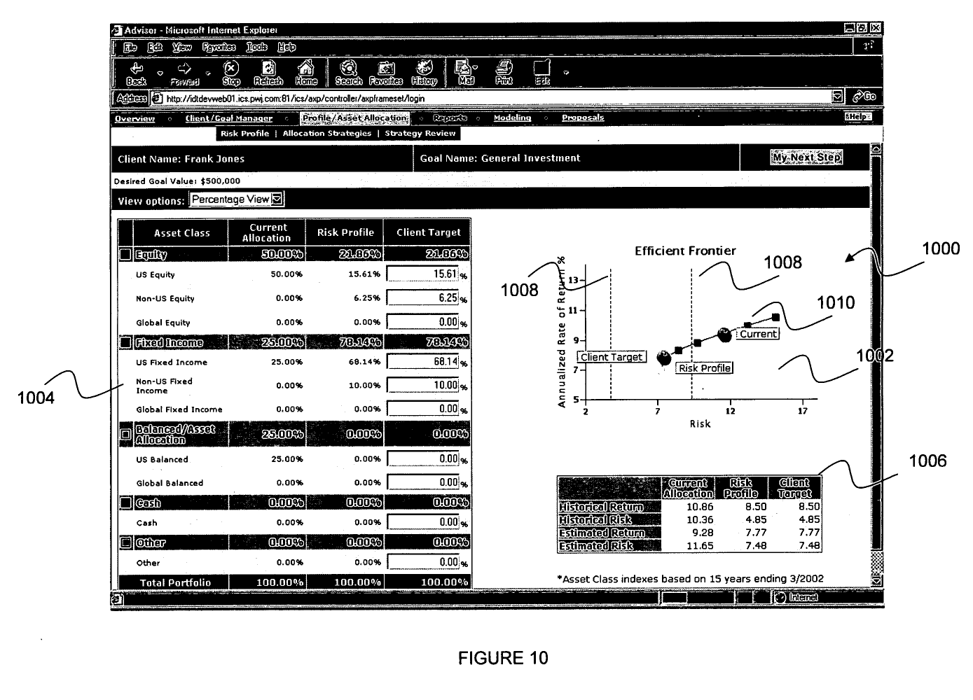

Once an investor's risk and investment profile has been formulated, the Advisor enables a user to select an asset allocation suited to the investor and the investor's goal and/or create a customized asset allocation in light of specific goal objectives. For example, in the context of a particular goal, an investor may desire to increase/decrease risk taken to achieve a particular objective. By exciting the Allocation Strategies subtab 806 (illustrated in FIG. 8), a user may trigger display of an Allocation Strategies screen, an example of which being illustrated in FIG. 10. As illustrated in that figure, the Allocation Strategies screen 1000 displays data indicating an investor's goal value by asset class according to current allocation, risk profile allocation and the adjustable investor target allocation in either percentage or dollar values.

The Allocation Strategies screen is configured to display a plurality, for example, three specific allocation strategies: current, risk profile and target. The current allocation strategy is based on how the assets in the investor's accounts linked to a goal are diversified. The risk profile allocation strategy suggests how assets should be allocated according to the investor's risk profile. The target allocation represents the allocation strategy a user has chosen to adopt for an investor's investment plan. It does not necessarily reflect a strategy recommended by a financial advisor.

FIG. 10 illustrates an example of the Allocation Strategies screen 1000 including an efficient frontier graph 1002 presented on the right of the Allocations Strategies screen 1000. The display of the graph 1002 may be triggered by selecting the Modify Target Allocation Strategy option from a drop down menu associated with the MNS icon or by exciting the Allocation Strategies subtab 806 (illustrated in FIG. 8). The Allocation Strategies screen 1000 is configured to display an efficient frontier graph, which identifies a goal's rate of return for the current allocation, risk profile allocation and investor's target allocation. The user can view the Allocation Strategies screen 1000 by percentage or dollar values. The Allocation Strategies screen functionality may only be available for goals that have been profiled. Thus, if a goal has not been profiled, tab for this screen located on other screens is disabled.

The Allocation Strategies screen functionality is available for goals that have not been quantified. In such a situation, the goal value may be set to $0 and the current allocation, risk profile allocation and investor target may be displayed.

The Allocation Strategies screen 1000 may include an efficient frontier graph 1002 that allows a user to click on various parts of the graph to trigger adjustment of investor target percentages accordingly. The various degrees of risk identified in the efficient frontier may include clickable points (risk buckets 1010 explained herein) relating to very conservative, conservative, moderately conservative, moderate, moderately aggressive, aggressive and very aggressive allocation strategies.

The Allocation Strategies screen 1000 may also include a chart 1004 of the investor's total portfolio including current allocation risk profile allocation and investor target allocation. All of this data may be displayed by asset class. The sum value of the target allocation assets may always equal the total value current assets of the existing portfolio/goal, as that represents the assets available for investment. If the value of the cash broad asset class is greater than or equal to $0 (when displaying a dollar value), the cash row of the current allocation column will display the actual value of cash and the total row of the current allocation column, will be changed from “Total” to “Total Portfolio.” If the aggregate value of the cash broad asset class is less than $0, the cash row of the current allocation column will display $0 or 0%, depending on the view, and the total row of the current allocation column, will be changed from “Total” to “Total Securities”; an additional two rows below the total securities row are added: a row titled “Net Liabilities”, which includes the actual value of the cash broad asset class under the current allocation, and a row titled “Total Portfolio”, which includes the sum of the total securities and net liabilities under the current allocation column.

For a goal with a negative cash balance, the weighted return and risk of the current allocation should be based on the revised allocation, considering only the broad assets classes that add up to Total Securities.

The current allocation, risk profile allocation and investor target allocation values default to percentage % rather than dollar figures. A default view may include all asset class designations (e.g., balanced/global investments) for both the current allocation and the investor target allocation. If the investor's risk profile is altered, the investor target allocation may be automatically changed to match the risk profile allocation regardless if the investor target allocation had been previously modified.

Chart 1006 including text data providing quantitative values associated with the graph. On this chart 1006, the investor risk profile allocation and investor target allocation are assumed to be identical at the time of initial profile completion. The historical risk/return data may be based upon index performance for some previous period of time, e.g., the previous 15 years.

Based on modern portfolio theory, the “efficient frontier” is an effective way to analyze the interaction of expected risk and return. The first step in constructing an efficient frontier is to plot every combination of assets (e.g., different asset allocation strategies) on a risk/return graph. Thus, the efficient frontier represents the line created by plotting and connecting all asset class combinations which produce the highest return for each degree of risk taken. The efficient frontier graph 1002 represents the set of portfolios that has the maximum rate of return for every given level of risk, or the minimum risk for every level of return. The two dotted vertical lines on the graph represent the risk bands 1008 associated with the investor and/or the investor's specific goal, the position of which are determined from the answers to the risk profile questions, explained above. The vertical dotted lines 1008 on the efficient frontier graph 1002 represent the (±) acceptable variance for the investor's risk profile to reach his or her goal, based on an estimated return. Investment strategies that lie outside these bands 1008, either to the right (too much risk) or to the left (not enough risk), are deemed to be outside the investor's risk tolerance range. Analysis of investment strategies that contain target allocations to the left of the risk bands may have special footnotes, which remind investors they are not taking on a level of risk commiserate with their risk profile. Target allocations to the right of the outer most risk bands may not be permitted.

The efficient frontier graph 1002 shows the current allocation and the risk profile allocation pie. The current allocation is based on a proprietary classification of assets according to class and category. Should this allocation include assets and accounts held at another firm, including 401(k) plans with employers, they may be incorporated based on information which a user have provided.

By default, the-investor target allocation (which represents the present allocation of the existing goal portfolio(s)) matches the risk profile allocation (which represents the firm's recommended portfolio based upon the investor/goal's risk/retum characteristics). However, the investor target allocation may be changed by exciting any of the seven optimized risk allocation buckets located along the efficient frontier or by manually changing the values in the fields under the investor target heading. Such changes may be subsequently reset or saved.

The user can view the efficient frontier graph 1002 and make modifications to the target allocation by exciting the selectable buckets 1010.

Following a user altering the asset allocation on the Allocation Strategies screen 1000, activation of a reset button (not illustrated) included on the Allocation Strategies screen 1000 may trigger display of the previously saved asset allocation.

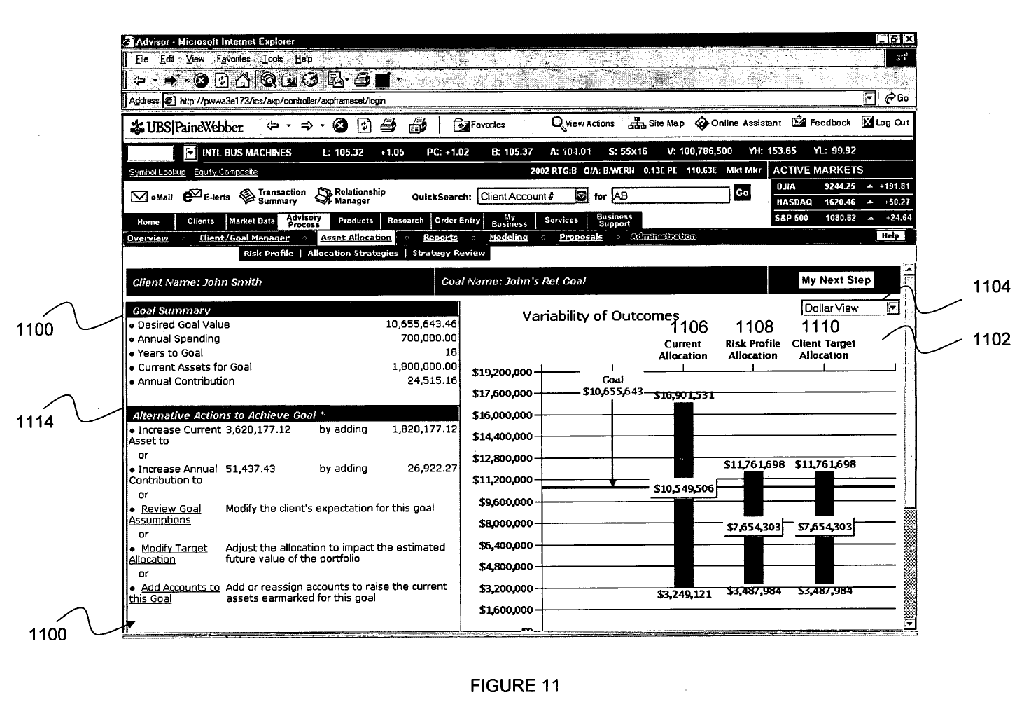

The Advisor system may also enable a user to generate recommended investment solutions through a model building feature. More specifically, a user can create an investment solution that may be saved as an investment model, draw from investment firm-wide models or maintain existing models. Exciting the Strategy Review subtab 808 (see FIG. 8) may trigger display of an Investment Proposal screen (an example of which being illustrated as screen 1100 in FIG. 11). The Investment Proposal screen functionality is only available for goals that have been profiled (that. is, have a risk profile completed for the goal). Thus, if a goal has not been profiled, the tab for the Investment proposal screen located on other Advisor screens is disabled.

The Investment Proposal screen 1100 displays a variability of outcomes chart 1102. This chart 1102 displays the range of outcomes that each strategy could provide at the end a of a specified time horizon.

To determine the range of possible outcomes, the Advisor may use probability statistics, which take into account the variability and uncertainty of returns. Specifically, the estimated annualized return and estimated risk for each allocation may be used when calculating the probabilities. Assuming a constant asset allocation, annual contributions as indicated, and no withdrawals, there may be a 90% probability that the allocations' future values will be less than the highest value illustrated and a 90% probability that they will be higher than the lowest value illustrated at the end of the time horizon. Furthermore, the majority of the potential outcomes may tend to aggregate around both sides of the estimated future value.

The chart 1102 may display information in a dollar view or a percentage view depending on which is selected in field 1104. The chart 1102 lists current allocation 1104, risk profile allocation 1106 and client target allocation 1108.

The risk profile allocation 1108 (dollar and percentage view) is the recommended allocation based on the data included in the investor's profile. The investor target allocation 1110 (dollar and percentage view) is initially equal to the risk profile allocation. However, on the Allocation Strategies screen (an example of which being illustrated as 1000 in FIG. 10), the user may manually change the investor target asset allocation 1106.

The maximum value of the current allocation 1106 represents the estimated amount the investor will accumulate for the goal, using a high estimated growth rate based on the investor's current allocation. The mid value of the current allocation 1106 represents the estimated amount the investor will accumulate for the goal, using the average estimated growth rate, based on the investor's current allocation. The minimum value of the investor's current allocation 1106 represents the estimated amount the investor will accumulate for the goal, using a low estimated growth rate, based on the investor's current allocation.

The maximum value of the risk profile allocation 1108 represents the estimated amount the investor will accumulate for the goal, using a high estimated growth rate based on the investor's risk profile allocation. The mid value of the risk profile allocation 1108 represents the estimated amount the investor will accumulate for the goal, using the average estimated growth rate, based on the investor's risk profile allocation. The minimum value of the risk profile allocation 1108 represents the estimated amount the investor will accumulate for the goal, using a low estimated growth rate, based on the investor's risk profile allocation.

The target allocation 1110 represents the allocation strategy the user has chosen to adopt for the investor's investment plan. It does not necessarily reflect a strategy recommended by the investment firm. The maximum value of the investor target allocation 1110 represents the estimated amount the investor will accumulate for the goal, using a high estimated growth rate based on the investor's target allocation. The mid value of the investor's target allocation 1110 represents the estimated amount the investor will accumulate for the goal, using the average estimated growth rate, based on the investor's target allocation. The minimum value of the investor's target allocation 1110 represents the estimated amount the investor will accumulate for the goal, using a low estimated growth rate, based on the investor's target allocation.

The risk adjusted allocation and target allocation are assumed to be identical at the time of an initial profile completion.

The screen 1100 also includes a Goal Summary section 1112, which includes overview data regarding the goal including, e.g., the desired goal value, annual spending, years to goal, current assets for goal and an annual contribution. The screen 1112 also may include an Alternative Actions section 1114, which may display alterative actions that may be used to achieve the goal identified in the Goal Summary section 1112.

To determine the correct value for the years to goal included in the Goal Summary section 1112, the following risk profile answer logic may be used for years to goal (n): less than 3 years, n=3; 3 to 6 years, n=6; 7 to 10 years, n=10; and longer than 10 years, n=15. To calculate a blended rate of return for an asset or group of assets, the weight of each subclass in an assets allocation may be calculated by dividing the amount allocated to each subclass by the total asset balance. Next, the weighted growth of each subclass in the allocation may be calculated by multiplying the weights of each subclass by that subclass' growth rate (this may be a known value, stored in a database accessible by or included in the backend of the Advisor). Finally, all the weighted growths may be added together to provide the blended rate of return for the asset.

To calculate a standard deviation for an asset, or group of assets, a calculation (assuming five subclasses) of the formula:
σ=w₁²σ₁²+w₂²σ₂²+w₃²σ₃²+w₄²σ₄²+w₅²σ₅²+2w₁w₂p_{1,2}σ₁σ₂+2w₁w₃p_{1,3}σ₁σ₃+2w₁w₄p_{1,4}σ₁σ₂+2w₁w₅p_{1,5}σ₁σ₅+2w₂w₃p_{2,3}σ₂σ₃+2w₂w₄p_{2,4}σ₂σ₄+2w₂w₅p_{2,5}σ₂σ₅+2w₃w₄p_{3,4}σ₃σ₄+2w₃w₅p_{3,5}σ₃σ₅+2w₄w₅p_{4,5}σ₄σ₅ (5)

provides the standard deviation, where w, is the weighted growth for subclass x,σₓ is the standard deviation for subclass x (a constant value stored in the database) and p_{x,y} is the correlation between subclass x and subclass y (constant value stored in the database).

To calculate the high rate of return, the following formula is used.

$$High = {ⅇ}^{{\{ ln ( 1 + u ) - \frac{ln \{ 1 + {[ \frac{σ}{( 1 + u )} ]}^{2} \}}{2} - 1.2816 \cdot \sqrt{\frac{ln \{ 1 + {[ \frac{σ}{( 1 + u )} ]}^{2} \}}{n}} \}}_{- 1}} \qquad ( 6 )$$

To calculate the low rate of return, the following formula is used.

$$Low = {ⅇ}^{{\{ ln ( 1 + u ) - \frac{ln \{ 1 + {[ \frac{σ}{( 1 + u )} ]}^{2} \}}{2} - 1.2816 \cdot \sqrt{\frac{ln \{ 1 + {[ \frac{σ}{( 1 + u )} ]}^{2} \}}{n}} \}}_{- 1}} \qquad ( 7 )$$

In calculating both the high and low rates of return, u is the blended rate of return, σ is the standard deviation, n is the number of years (for 1-3 years horizon n=3; for 4-6 years horizon, n=5; for 7-10 years horizon, n=8.5; for 11+years horizon, n=15).

If a goal has not been qualified, a goal value will not be displayed; rather an estimated value for current, risk profile and investor target allocations will be displayed. Also, if the goal has not been quantified, the time horizon (n=time) matrix may be obtained from the investor's risk profile. In such a case, the Risk Profile screen's time horizon calculation may be used in the calculation of a variability of outcomes high/low range, as well as an estimated future value, for all three allocation portfolios.

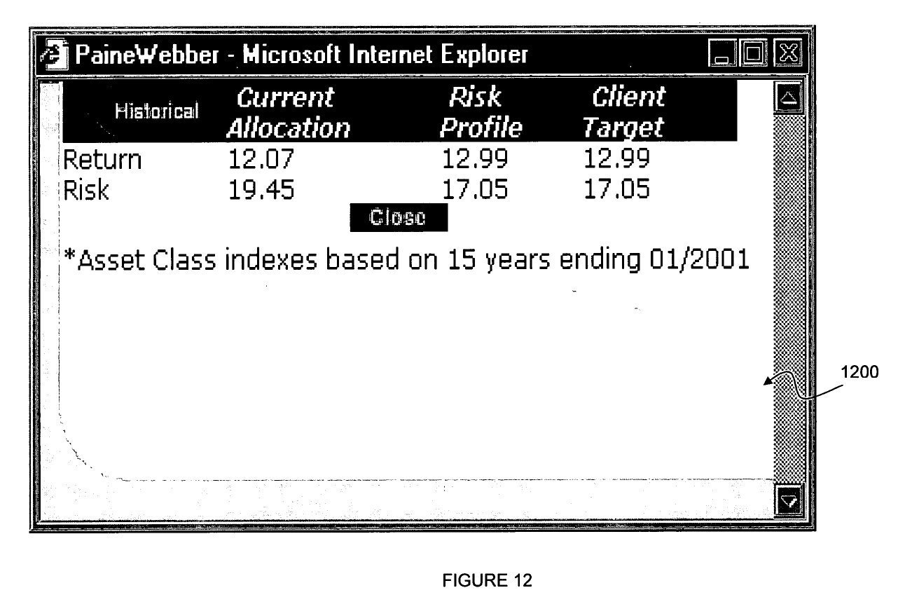

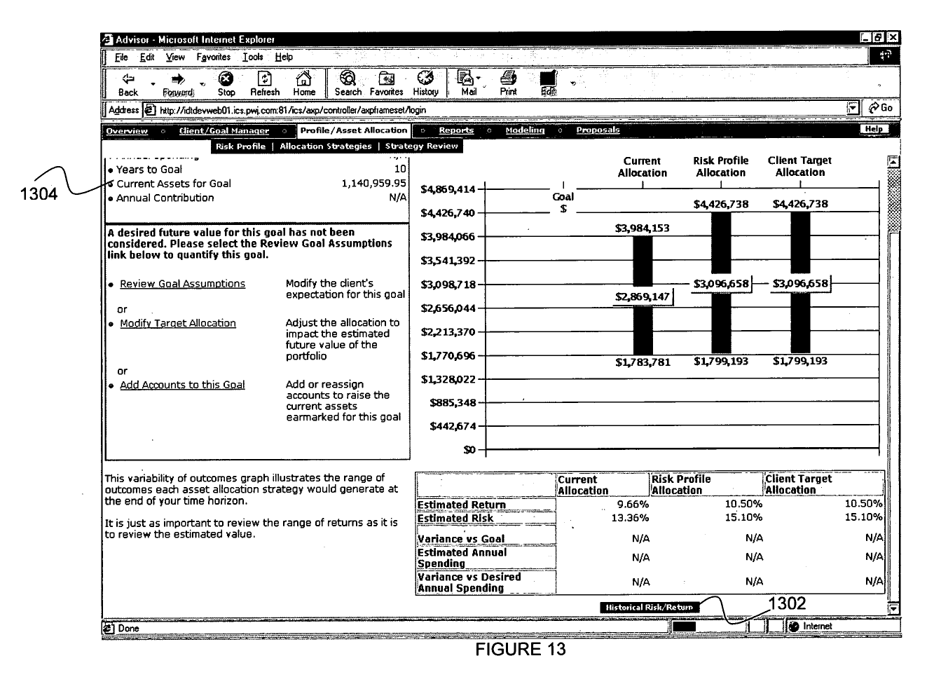

Included on the Investment Proposal screen 1100 is a Historical Rate of Return icon (not illustrated in FIG. 11 but illustrated as 1302 in FIG. 13), which, when activated, triggers display of a Historical Rate of Return screen. FIG. 12 illustrates an example of the Historical Rate of Return screen 1200, which displays the rates of return for various allocations(current, risk adjusted and target) over some historical period of time, e.g., fifteen years.

If the goal has not yet been quantified, the form and content of the Investment Proposal screen illustrated in FIG. 13 may be displayed. In such a case, the Goal Summary section 1304 may include a message indicating that a desired future value for the goal has not been considered because no desired future value has been set by quantifying the goal. Such a message may also provide instructions to the user as to how to quantify the goal.

If the goal has been quantified, the risk return variable is determined from “Years to Goal”. If a goal has been quantified, the ‘Years to Goal’ value (n) is used in the calculation of the variability of outcomes high/low range, as well as the estimated future value, for all three allocation portfolios.

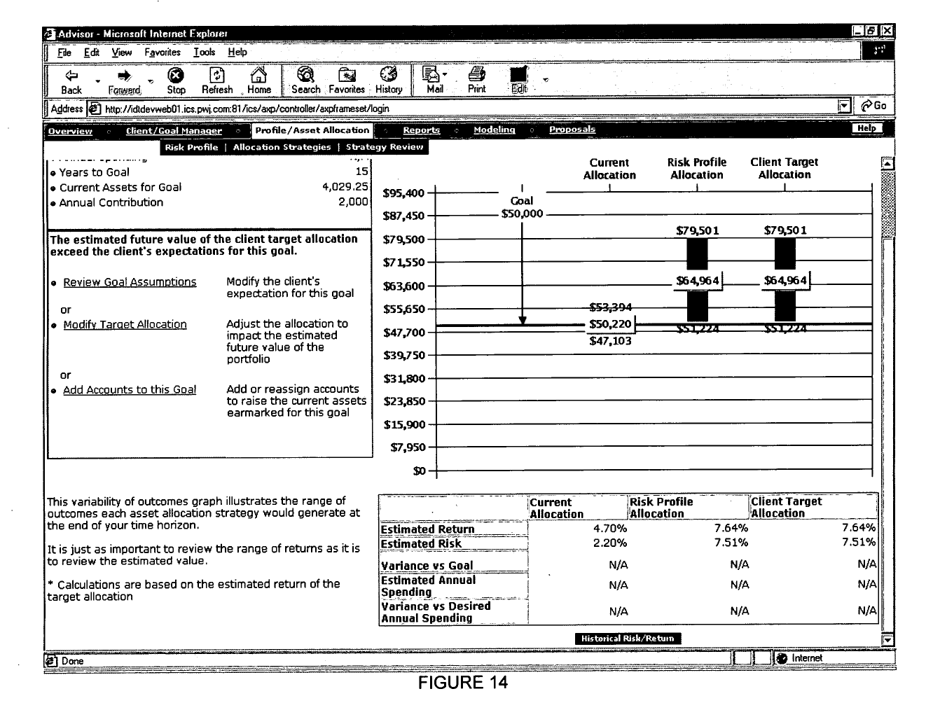

If the investor's target estimated financial value exceeds the desired goal value, alternative actions to achieve the goal are not displayed in the Alternative Actions section 1112. Thus, the form and content of the Investment Proposal Screen illustrated in FIG. 14 may be displayed.

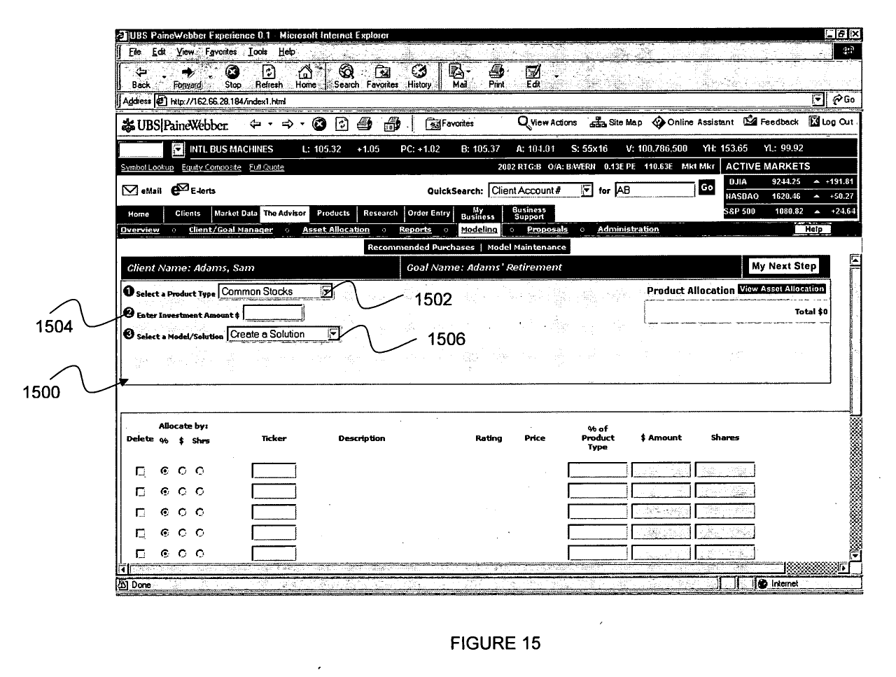

The asset allocation strategies presented by the Advisor may combine optimization and statistical modeling based on proprietary capital market assumptions and investment judgment. As explained above, this methodology may be consistent with how the probability of the investor's ability to reach their goals is determined. Additionally, analysts across different product and research areas within the investment firm associated with the Advisor may collectively work to determine various asset class characteristics. These may include expected return, risk and correlations and may be based on a combination of historical performance, proprietary research, and a current assessment of economic and financial market conditions. The framework for this strategic view may be based on a building block methodology, which may begin with establishing an inflation expectation and building upon it. Once each asset class is analyzed and expectations are determined, an overall market view may be presented. This overall market view may be reviewed and analyzed via a Recommended Purchases screen (an example of which being illustrated as 1500 in FIG. 15).

At the Recommended Purchases screen 1500, the user can elect to perform a review of various different products including taxable fixed income investments, municipal bond products, mutual funds, cash/cash equivalents, or other financial products. Display of the Recommended Purchases screen 1500 may be triggered by a user exciting the Modeling tab 216 on the Investor/Goal Manager screen (an example of which being illustrated as 200 in FIG. 2), a user can select a product type using a drop down menu 1502 that includes, e.g., various options including equities, mutual funds, taxable fixed income, municipal products, cash/cash equivalents and other products. Each of these options may be associated with its own sub menu. Once the product type is selected, the user will be prompted to enter an investment amount in the Investment field 1504. Subsequently, the user may create a model/solution, access a preexisting firm-wide model or a model previously developed by the user by selecting one of these options from the Model/Solution drop down menu 1506. The drop down menu 1506 may default to a Create a Model Solution option, which may allow a user to enter securities. The price and rating of the security may be populated with data from a previous business day's closing financial market data. Alternative, a user can also select an existing firm model to apply to a goal's investment recommendation.

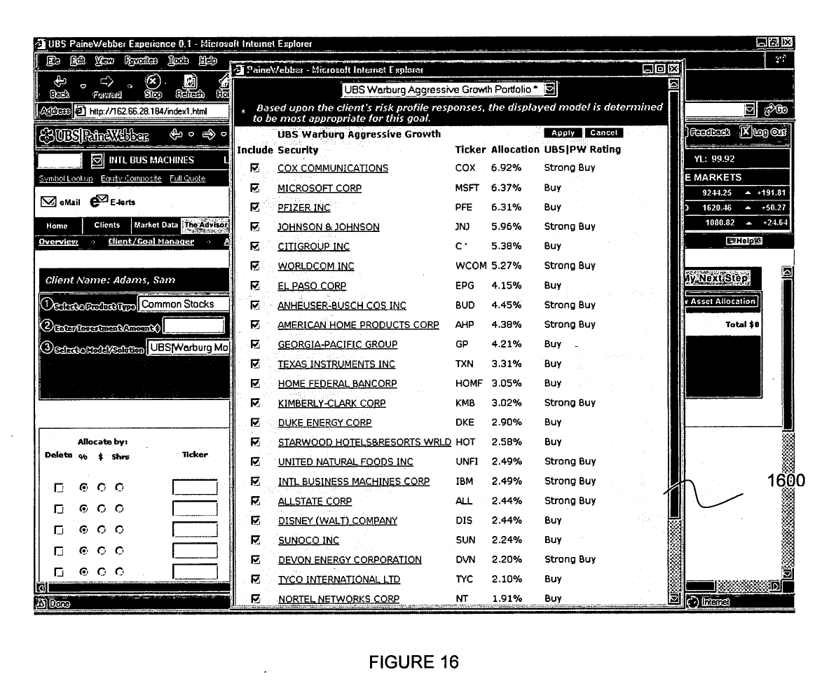

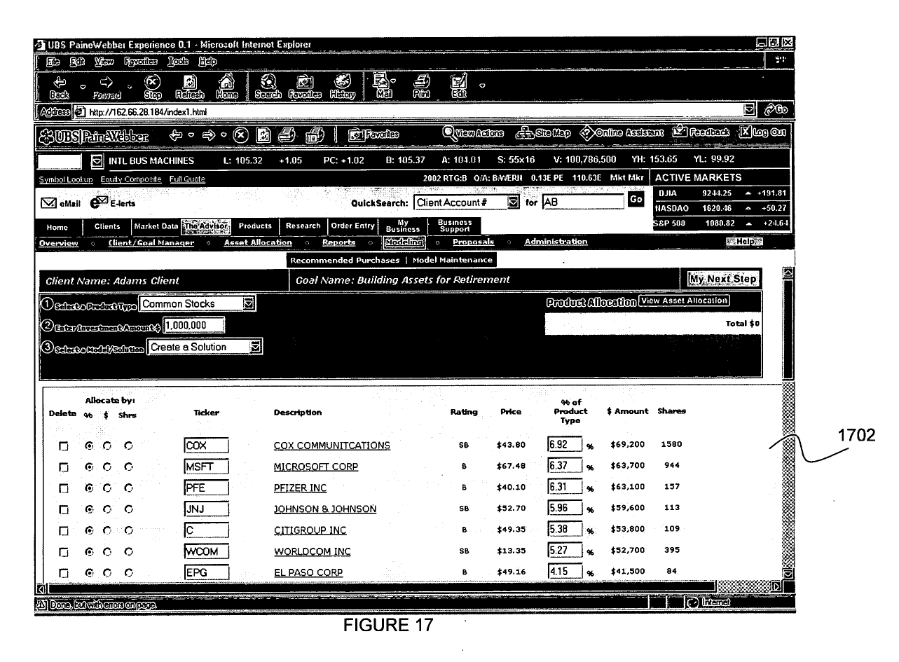

When a user wishes to access firm-wide models, a pop-up window, such as the window 00 illustrated in FIG. 16, may be generated that displays a portfolio recommendation selected based on the investor's risk profile. A user may chose to include or omit various securities listed in the recommended portfolio by selecting or deselecting the securities. When the user is satisfied with the portfolio recommendation, the user may excite the Apply icon (not illustrated) to trigger application of the investment amount in the proportional amount allocated in the portfolio recommendation. As a result, the Recommended Purchases screen may be displayed and include a list of associated purchases recommended by the Advisor included in a Recommended Purchases section 1702 as illustrated in FIG. 17.

The user may use a firm-wide model to create a new model associated with the user. To do so, the use may access the firm-wide model to trigger display of a firm model identified by the Advisor as the most appropriate model to the investor's goal based on the investor's risk profile. If the model is acceptable, the user may excite the Apply icon to apply the investment amount to the portfolio model; this may trigger display of the investment amount broken down by asset allocation with the recommended portfolio. Once the allocations have been reviewed and satisfactorily edited by the user, the user may save the resulting model as one of the user's own models.

When a user selects a Create a User Model option, the default model may be a recommended model (if there is one) for a product type identified by the user. The recommended model is determined by four factors: the investor's risk profile, the user's time horizon (e.g., intermediate, long, short), their tax preference and income type (e.g., total and current). If a model is created and there are pre-existing equities, the value of the stocks in the model may be pro-rated based on the following formula:
Vᵢ=(I−V_{$})*Pᵢ (8)
where I=Initial Investment
V_{$}=Value of equity allocated by $.
Vᵢ=Value of ith security in model, i=1 . . . n (n=number of securities in model)
Pᵢ=Percentage of ith security in model (percentages are displayed to two decimal places)

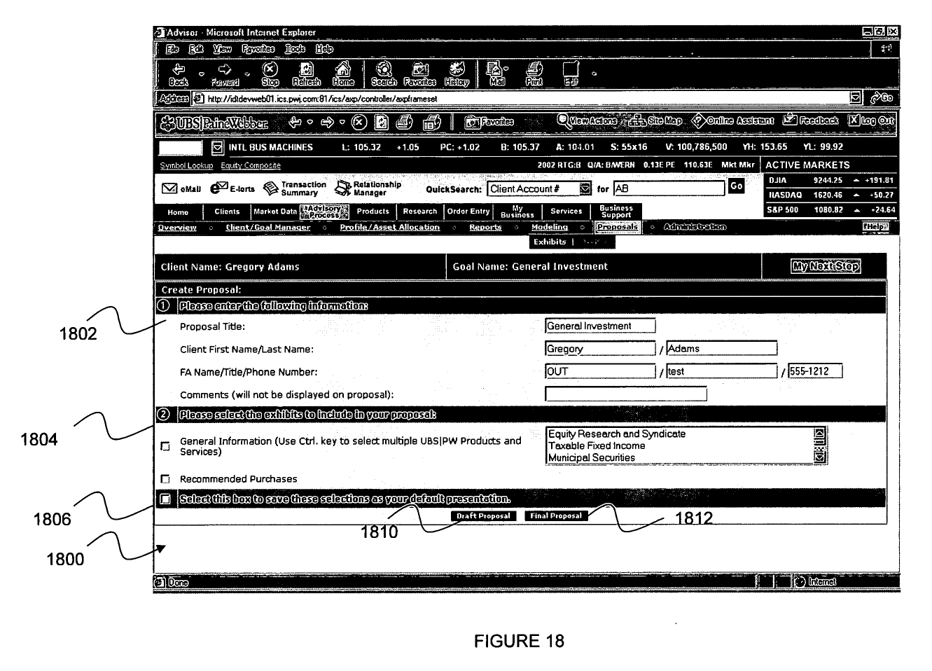

Users and investors may collaboratively modify the allocations developed using a Recommended Purchases screen to develop an investment proposal tailored to the investor's individual needs and circumstances. A user exciting the Proposals tab 218 on the Investor/Goal Manager screen (see FIG. 2) may trigger display of a Proposal Generation screen (an example of which being illustrated as 1800 in FIG. 18) that allows a user to create a proposal on line for an investor or a prospect. Display of the Proposal Generation screen 1800 may also be triggered by a user exciting the MNS icon on various screens of the Advisor and selecting the Generate Proposal option.

The Proposal Generation screen 1800 may include a general information section 1802 for entering general information related to the proposal including proposal title, investor first name and last name, user name, title and other contact information and a comments section for private comments regarding the proposal that are not included in the proposal itself.. The proposal title may default to the selected goal name but may be edited. The Proposal Generation screen 1800 may also include an exhibit selection section 1804 for entering selections of which exhibits to include in a proposal, e.g., informational reports on various firm products and services such as equities, taxable fixed income, municipal securities, alternative investments, asset management, mutual funds, annuities and insurance, personal trusts, financial planning, lending, managed account services, etc.

Default settings may display the same selected exhibits every time the user enters the Proposal Generation screen 1800 (regardless of investor/goal context). These default settings may be set based on the user rather than the investor or investor goal level. If the user has saved a set of default exhibit selections (e.g., by selecting the box 1806, requesting to save the selections as a default presentation), then they will be displayed, pending all previous conditions are met.

If the user has not used the Advisor to recommend purchases for the investor or prospect using the Recommended Purchases screen, an option to select an investment recommendation may be disabled from the exhibit preferences section 1804. If a goal does not have a risk profile associated with it, only the general information exhibit may be selected. In such a situation, all other exhibits may be grayed out for selection and the final proposal icon 1812 may be disabled.

The Generate Proposal screen 1800 includes a Draft Proposal icon 1810 and a Final Proposal icon 1812. Following excitation of the Draft Proposal icon 1810, a draft proposal is generated based on the data input in sections 1802 and 1804 and previous analysis performed for this investor/prospect and the selected goal (e.g., goal quantifying and risk profiling).

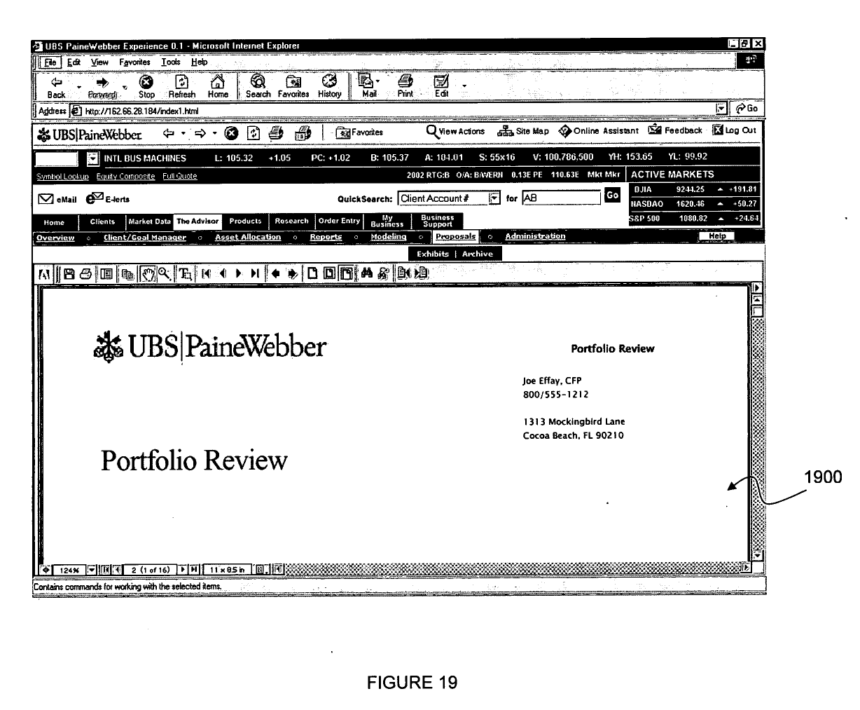

This generated draft proposal is then displayed in an Acrobat Reader window, an example of which being illustrated as 1900 in FIG. 19. The Acrobat Reader window 1900 is not actually a screen but a PDF document that is generated by the Advisor. All proposal preview pages may be displayed with a “DRAFT” watermark. The first page of the draft proposal may be for internal use only, e.g., a managerial review form, not to be attached to a finalized proposal to be given to an investor. The draft proposal's second page may be, e.g., a cover page, followed by a table of contents, one or more advisory pages, one or more goal summary pages, asset profile and risk profile pages, firm specific pages (e.g., promotional and/or background information), pages detailing the client's target allocation strategy products and services, and one or more explanatory information pages including, for example, a glossary of terms used in the proposal.

Following review of the draft proposal, the user can finalize the proposal by exciting the Final proposal icon 1812. Once a user has finalized the proposal it is automatically archived and no longer editable.

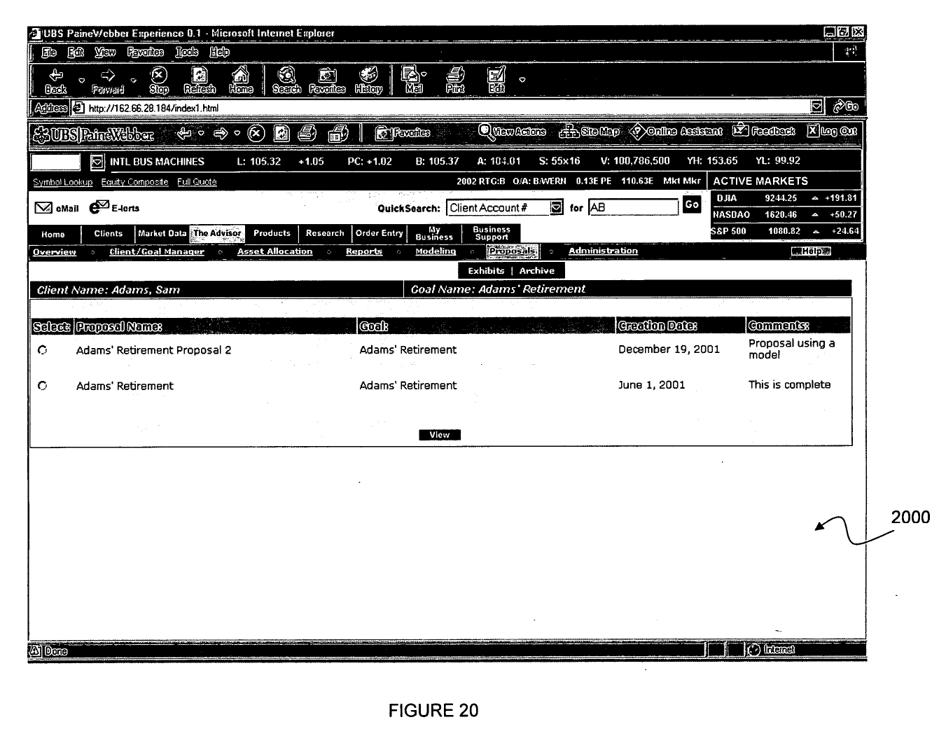

Although the finalized proposals are automatically archived, draft proposals may also be archived. FIG. 20 illustrates an example of a Proposal Archive screen 2000. The Proposal Archive screen 2000 may contain all saved investor proposals that are related to the goal in context. The Proposal Archive screen 2000 may show all saved investor proposals for a defined goal and may be viewed, or reprinted at a later date. When an investor proposal is saved, it may be archived as a PDF document. If an archived proposal is viewed or printed, the proposal date may display the original save date. No edits/modifications may be made to an archived proposal.

All proposals, both draft and investor, with investment recommendations that are regenerated on the same day the proposal is created may maintain the originally entered security prices. If the proposal is regenerated on any subsequent day (creation date +1, 2, . . . n), the security prices must be updated.

Similarly, if the user attempts to generate a proposal that has close of business day security prices/ratings that are more than I day old, the Advisor may require that the user view the Recommended Purchases screen (an example of which being illustrated as 1500 in FIG. 15) to update prices and ratings. Also, if a common stock, included in a recommended purchase, has been downgraded intra-day to reduce or sell, the Advisor may require that the user view the Recommended Purchases screen whereby the security may be deleted from the recommendation. However, when a user is sent to the Recommended Purchase screen, all previous exhibit selections may be systematically saved for the session.

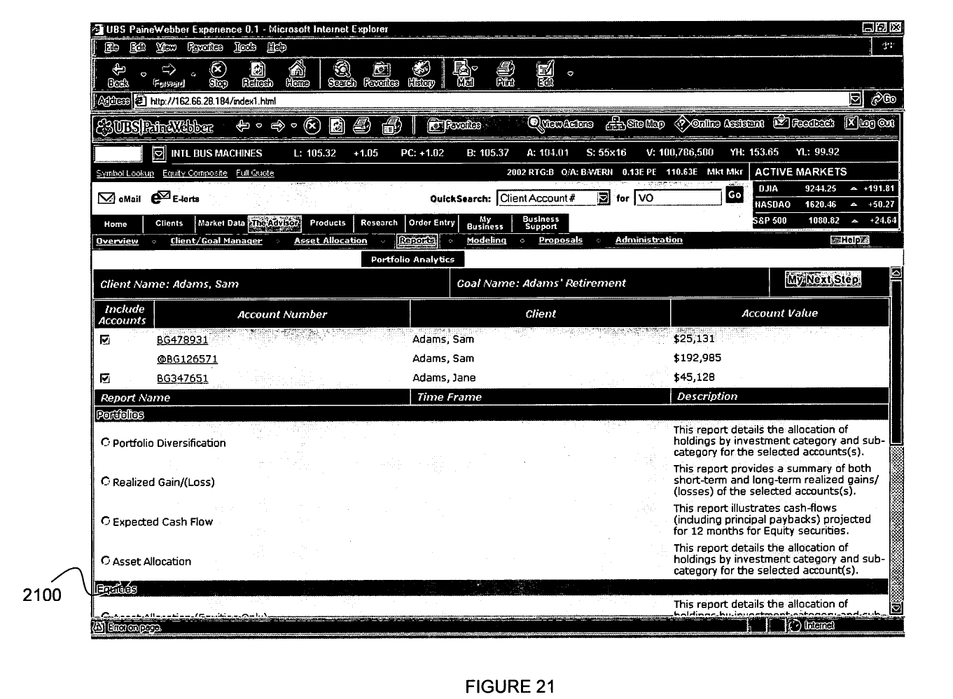

The Advisor may also enable a user to view and/or print reports, e.g., HTML files of reports, for any combination of accounts associated with a particular goal identified by the user. A user exciting the Reports tab 214 on the Investor/Goal Manager screen (see FIG. 2) may trigger display of a Portfolio Analytics screen (an example of which being illustrated as 2100 in FIG. 21) that enables a user to leverage portfolio management reporting that may provide more comprehensive reporting capabilities for an investor or prospect. It provides the ability to review and analyze an multiple accounts regardless of the financial investment product type.

The screen 2100 defaults to no reports chosen. Reports to be generated must be selected. Functionality allows accounts associated with the selected goal to be included or excluded using a checkbox. All associated goal accounts will default as checked to be included in reports, but can be de-selected if user chooses to not include them. If the user selects multiple accounts, any report will consider the accounts in aggregate. The user may view any of the displayed analytic reports in HTML (HyperText Markup Language) format.

Reports may include: Portfolio Diversification, Realized Gain/Loss, Expected Cash Flow and Asset Allocation. A user can also select from a variety of equity and fixed income reports. For example, the Advisor may generate a General Asset Allocation report which may include information regarding general assets such as mutual funds. A Portfolio Diversification report provides an easy-to-read format for reviewing assets held in an account by security and asset class. It also offers a consolidated look at tax lots and the market value of each position, while providing an overall picture of diversity within the account. A realized Gain/(Loss) report summarizes and separates short-term and long-term gains/(losses). The information in this report may include tax lot dates, realized gain/(loss) amounts and percentages, and transaction terms (short or long).

An Expected Cash Flow report reflects the anticipated projected cash flows for twelve-month period for both equity and fixed income securities for the selected account(s). Cash flows may be excluded for cash, money markets, and option securities. The user may have the option either to include or exclude the principal paybacks on fixed income securities. An Asset Allocation report is similar to the Portfolio Diversification report, except that it allows the user to review the allocation of holdings by investment category and a sub-category for the selected portfolio. This report may also identify mutual funds by their respective equity, fixed income, or balanced investment category. Mutual Funds that are not classified may be reported in another category.

A Sector Allocation report allocates solely U.S. common stock holdings by sector for a specified portfolio(s) and specifies sector weightings for the U.S. common stock equity portion of the portfolio(s). A utility of this report is that it includes ratings on each of the equity holdings. It also may offer a 36-month change showing the volatility of the equities in the portfolio(s).

A U.S. Fixed Income Maturity report may alert the user of the timeframe in which a selected portfolio(s) U.S. fixed income holdings will expire. Securities not listed with maturity dates may fall into another category on the report. The report may also include Moody's and Standard & Poor's credit ratings. A U.S. Fixed Income Credit Quality and Sector Allocation report displays these credit quality ratings for selected portfolio(s) U.S. fixed income securities. This report also provides the percentage of holdings by the U.S. fixed income sector categories.

Also supported by the Advisor, but not illustrated, is an External Accounts Manager screen that, along with back-end functionality, enables creation of external accounts that capture both the value and allocation of assets not maintained by an investment firm associated with the Advisor. The External Accounts Manager screen may include queries and input fields related to whether an account is an Individual Retirement Account qualified plan, the identity of the associated custodian, bank or broker/dealer, and the relative allocation of the external assets.

The Advisor also includes various screens and associated utility modules relating to and enabling administration of the Advisor and assistance to a user using the Advisor.

While this invention has been described in conjunction with the specific embodiments outlined above, it is evident that many alternatives, modifications and variations will be apparent to those skilled in the art. Accordingly, the embodiments of the invention, as set forth above, are intended to be illustrative, not limiting. Various changes may be made without departing from the spirit and scope of the invention.

1. A system configured to output financial investment advice regarding investments in an investment portfolio associated with a designated goal based, at least, on an investor's risk and investment profile data information provided by a user, the system comprising:
a front-end including a plurality of graphical user interfaces configured to receive a user's identification of an investor's risk and investment profile data; and
a back-end configured to, at the direction of the user via the front-end, identif one or more recommended investments, and an allocation of funds among those investments, based on the investor's risk and investment profile, a time horizon and a type of the designated goal.

2. The system of claim 1, wherein the back-end and front-end cooperate to receive data input by the user regarding the investor, analyze the input investor data along with data associated with at least one financial investment marketplace, and identify and output, via the front-end, one or more recommended investments, and the allocation of funds among those investments based on the investor's risk and investment profile, time horizon, type of the designated goal and the data associated with the at least one financial investment marketplace.

3. The system of claim 1, wherein the back-end is configured to, at the direction of the user via the front-end, recognize relationships between multiple investors and to determine, and output via the front-end, data indicating recommended potential investments for the investment portfolio associated with the designated goal, the investment portfolio including investments associated with a plurality of investors identified in a relationship.

4. The system of claim 3, wherein the relationship recognized is one of husband-wife, parent-child, grandparent-grandchild, guardian-ward, and business partners.

5. The system of claim 1, wherein the goal is one of education of a child, education of a grand-child, education of a ward, education of one's self, building assets for retirement, maintaining assets for current retirement, assuring family income in the event of an untimely occurrence, purchasing a new or second home, building an investment portfolio, and building an emergency fund.

6. The system of claim 1, wherein a warning is generated and output to the user via one or more screens of the front-end if a risk level for a selected investment vehicle is inconsistent with the investor's risk and investment profile.

7. The system of claim 1, wherein the back-end calculates a blended rate of return for an investment, including high and low rates of returns, and a standard deviation for an asset or group of assets.

8. The system of claim 1, wherein the back-end generates an investment proposal for a user describing a recommended investment portfolio based on data input by a user via the front-end, the investment proposal being associated with the designated goal.

9. The system of claim 1, wherein the back-end is implemented at least in part as a software application including one or more goals-based calculators, portfolio level reporting algorithms, and portfolio modeling algorithms.

10. The system of claim 1, wherein the front-end includes an Overview screen configured to serve as an entry port to the system and including one or more links to one or more advisory capability screens and one or more navigational icons, excitation of which triggering display of an associated screen or drop-down menu.

11. The system of 10, wherein one of the navigation icons is a My Next Step icon, excitation of which triggers display of a drop-down menu including navigational options based the actions previously performed by the user in connection with the investor and the designated goal.

12. The system of 11, wherein the system requires that a user must quantify the designated goal prior to creating a risk and investment profile for the designated goal.

13. The system of claim 1, wherein the plurality of graphical user interfaces include an Investor/Goal Manager screen, a Quantify Goal screen, a Profile/Asset Allocation screen, a Portfolio Analytics screen, a Proposal Generation screen and a Recommended Purchases screen.

14. The system of claim 13, wherein the Investor/Goal Manager screen is configured to enable a user to the search and/or create new investor or prospective investor entries, determine the investor's preferences, create additional goals, combine accounts under the same goal by forming relationships with other investors or prospective investors, and add outside accounts and associate the outside accounts with the designated goal of the investor.

15. The system of claim 14, wherein the Investor/Goal Manager screen is configured to display data associated with an investor identified by the user as well as any previously created financial goals and an indication of progress toward a goal value once the goal has been quantified.

16. The system of claim 13, wherein the Recommended Purchases screen is configured to review one of a plurality of products including taxable fixed income investments, municipal bond products, mutual funds, and cash/cash equivalents based upon a user selection of a product and an investment amount.

17. The system of claim 13, wherein the Proposal Generation screen is configured to receive input from a user indicating a selection of exhibits to be included with a generated proposal.

18. The system of claim 13, wherein the front-end includes a Portfolio Analytics screen configured to input and output data from and to a user, the data being associated with financial investment reports, which the system generates.

19. The system of claim 18, wherein the back-end is configured to, at the direction of the user received via the Portfolio Analytics screen included in the front-end, generate and output financial investment reports for any combination of investments associated with the designated goal regardless of financial investment product type.

20. The system of claim 19, wherein the reports include at least one of Portfolio Diversification, Realized Gain/Loss, Expected Cash Flow, General Asset Allocation, a Sector Allocation report, a U.S. Fixed Income Maturity report, and a U.S. Fixed Income Credit Quality and Sector Allocation report.

21. The system of claim 1, wherein the back-end includes at least one of an education calculation utility module, a retirement utility module and a saving utility module, each of which has one or more corresponding graphical user interfaces that are displayed by the front-end when the designated investor goal relates to the corresponding utility module.

22. A method for generating outputting financial investment advice regarding investments in an investment portfolio associated with a designated goal based, at least, on an investor's risk and investment profile data information provided by a user, the method comprising:
receiving, via at least one of a plurality of graphical user interfaces, a user's identification of an investor's risk and investment profile data; and
identifying, at the direction of the user via the at least one graphical user interface, one or more recommended investments, and an allocation of funds among those investments, based on the investor's risk and investment profile, a time horizon and a type of the designated goal; and
outputting the identified one or more recommended investments to the user.

23. The method of claim 1, further comprising receiving analyzing the input investor data along with data associated with at least one financial investment marketplace, and identifying and outputting, via the front-end, one or more recommended investments, and the allocation of funds among those investments based on the investor's risk and investment profile, time horizon, type of the designated goal and the data associated with the at least one financial investment marketplace.

24. The method of claim 22, further comprising:
recognizing relationships between multiple investors; and
determining, and outputting data indicating recommended potential investments for the investment portfolio associated with the designated goal, the investment portfolio including investments associated with a plurality of investors identified in a relationship.

25. The method of claim 24, wherein the relationship recognized is one of husband-wife, parent-child, grandparent-grandchild, guardian-ward, and business partners.

26. The method of claim 22, wherein the goal is one of education of a child, education of a grand-child, education of a ward, education of one's self, building assets for retirement, maintaining assets for current retirement, assuring family income in the event of an untimely occurrence, purchasing a new or second home, building an investment portfolio, and building an emergency fund.

27. The method of claim 22, further comprising generating and outputting, via one of the plurality of graphical user interfaces, a warning to the user if a risk level for a selected investment vehicle is inconsistent with the investor's risk and investment profile.

28. The method of claim 22, wherein the back-end calculates a blended rate of return for an investment, including high and low rates of returns, and a standard deviation for an asset or group of assets.

29. The method of claim 22, wherein the back-end generates an investment proposal for a user describing a recommended investment portfolio based on data input by a user via the front-end, the investment proposal being associated with the designated goal.

30. The method of claim 22, wherein one of the plurality of graphical user interfaces includes an Overview screen including one or more links to one or more advisory capability screens and one or more navigational icons, excitation of which triggering display of an associated screen or drop-down menu.

31. The method of 30, wherein one of the navigation icons is a My Next Step icon, excitation of which triggers display of a drop-down menu including navigational options based the actions previously performed by the user in connection with the investor and the designated goal.

32. The method of claim 22, further comprising:
based on direction of the user received via at least one of the plurality of graphical user interfaces, quantifying the designated goal; and
creating a risk and investment profile for the designated goal.

33. The method of claim 32, wherein designated goal is quantified before the risk and investment profile is created.

34. The method of claim 32, further comprising:
receiving data from the user via an Investor/Goal Manager screen, which is included in one of the plurality of graphical user interfaces; and
creating a new goal based on the received data and associating that new goal with a particular investor or prospect and one or more financial investments.

35. The method of claim 32, further comprising:
receiving data from the user via an Investor/Goal Manager screen, which is included in one of the plurality of graphical user interfaces; and
searching for an investor or a prospect based on the received data or creating an investor or prospect based on the received data.

36. The method of claim 35, further comprising displaying data associated with an investor identified by the user as well as any previously created financial goals and an indication of progress toward a goal value once the designated goal has been quantified.

37. The method of claim 23, wherein the plurality of graphical user interfaces includes a Recommended Purchases screen is configured to review one of a plurality of products including taxable fixed income investments, municipal bond products, mutual funds, and cash/cash equivalents based upon a user selection of a product and an investment amount.

38. The method of claim 23, further comprising receiving data input from a user via a Proposal Generation screen, which is included in the plurality of graphical user interfaces, the input data indicating a selection of exhibits to be included with a generated proposal.

39. The method of claim 23, further comprising generating and outputting financial investment reports for any combination of investments associated with the designated goal regardless of financial investment product type based on data received from a user via a Portfolio Analytics screen, which is included in the plurality of graphical user interfaces.

40. The method of claim 39, wherein the reports include at least one of Portfolio Diversification, Realized Gain/Loss, Expected Cash Flow, General Asset Allocation, a Sector Allocation report, a U.S. Fixed Income Maturity report, and a U.S. Fixed Income Credit Quality and Sector Allocation report.
